(19) United States
(12) Patent Application Publication
(10) Pub. No.: US 2024/0260717 A1
(43) Pub. Date: Aug. 8, 2024

(54) ARTICLE OF FOOTWEAR FOR IMPROVED BALL CONTROL

(71) Applicant: NIKE, Inc., Beaverton, OR (US)

(72) Inventors: Giovanni Adami, Montebelluna (IT); Maria Rosa Bazan, Vedelago (IT); Mauro Bordin, Crocetta del Montello (IT); Daren T. Cejna, Beaverton, OR (US); Gjermund Haugbro, Beaverton, OR (US); Stephan Hausmann, Happy Valley, OR (US); Fiona Lesecq, Beaverton, OR (US); Michele Tosello, Beaverton, OR (US); Francesco Zago, Castelfranco Veneto (IT); Simone Belotti, Reggio Emilia (IT); Mirko Bianconi, Castel d'Ario (IT); Nicolas Menghini, Castel d'Ario (IT); Luca Venturini, Porto Mantovano (IT)

(21) Appl. No.: 18/426,554

(22) Filed: Jan. 30, 2024

Related U.S. Application Data
(60) Provisional application No. 63/441,995, filed on Jan. 30, 2023.

(51) Int. Cl. A43B 23/02; B29D 35/06

(52) U.S. Cl. CPC A43B 23/0265; B29D 35/068

(57) ABSTRACT

Aspects herein are directed to a knitted upper and articles of footwear that incorporate the same that include raised elements that extend in a z-direction away from an outer surface of the knitted upper. The raised elements comprise a thermoformed network of interlooped yarns. A first set of raised elements extends in a first direction on a lateral side of the knitted upper, and a second set of raised elements extends in a second direction on a medial side of the knitted upper where the second direction is different from the first direction.

### CROSS-REFERENCE TO RELATED APPLICATIONS

This application claims the benefit of U.S. Provisional Patent Application No. 63/441,995, filed on Jan. 30, 2023, the entirety of which is hereby incorporated by reference.

### TECHNICAL FIELD

Aspects herein are directed to a knitted upper and an article of footwear made therefrom that include thermoformed raised elements to provide improved ball control.

### BACKGROUND

A variety of articles, including footwear, are formed of textiles, which are often formed by weaving or interlooping (e.g., knitting) a yarn or a plurality of yarns. In particular, an upper for an article of footwear may be formed from a knitted textile. To increase durability and/or water resistance, non-textile components may be added and secured (e.g., glued or stitched) to the textile. For example, cross-linked polyurethanes, synthetic leather textiles, laminate film layers, and the like can be used as durable covering layers. However, the addition of any extra layer, even a film, reduces the ability of the article of footwear to provide proprioceptive feedback to a wearer's foot, which can be particularly important for articles in certain sporting activities. In an article of footwear for football (also known in other geographical areas as soccer), for example, it may be important for a wearer to be able to feel the ball through the textile to facilitate ball control and handling.

With continued respect to articles of footwear for football, extra layers may also be used to provide a certain level of traction or grip for ball control and handling. In traditional articles of footwear, it may be difficult to fine-tune the amount of traction or grip imparted by the extra layers. For example, too much grip may interfere with the wearer's ability to perform quick touches and ball-handling maneuvers while too little grip may cause the ball to slide off the article of footwear. Additionally, when extra layers are used to provide traction or grip, the amount or the directionality of grip may be generally the same on both the medial and lateral sides of the article of footwear, which fails to address the different functions the medial and lateral sides of the article of footwear perform during wear (e.g., kicking using the medial side of the article of footwear and dribbling using the lateral side of the article of footwear).

### BRIEF DESCRIPTION OF THE DRAWINGS

Examples of aspects herein are described in detail below with reference to the attached drawing figures, wherein:

FIG. 1A illustrates a lateral view of an article of footwear having a first set of raised elements extending in a first direction in accordance with aspects herein;

FIG. 1B illustrates a medial view of the article of footwear of FIG. 1A and depicts a second set of raised elements extending in a second direction in accordance with aspects herein;

FIG. 1C illustrates a top view of the article of footwear of FIG. 1A in accordance with aspects herein;

FIG. 1D illustrates a medial view of the article of footwear of FIG. 1A with a different pattern for the second set of raised elements in accordance with aspects herein;

FIG. 2A illustrates a schematic representation of three interconnected courses of loops with the middle course being formed of a first yarn and the outer courses of loops being formed of a second yarn in accordance with aspects herein;

FIG. 2B illustrates a schematic representation of the interconnected courses of loops of FIG. 2A after being exposed to a thermoforming process in accordance with aspects herein;

FIG. 3A illustrates a portion of the first set of raised elements on the lateral side of the article of footwear of FIG. 1A in accordance with aspects herein;

FIG. 3B illustrates a cross-section taken at cut line 3B-3B of FIG. 3A and illustrates the first set of raised elements having different heights in the z-direction in accordance with aspects herein;

FIG. 4A illustrates a portion of the second set of raised elements on the medial side of the article of footwear of FIG. 1A in accordance with aspects herein;

FIG. 4B illustrates a cross-section taken at cut line 4B-4B of FIG. 4A and illustrates the second set of raised elements having different heights in the z-direction in accordance with aspects herein;

FIG. 5 illustrates a schematic of a first example manufacturing process for thermoforming one or more of the first set of raised elements and the second set of raised elements in accordance with aspects herein; and

FIG. 6 illustrates a schematic of a second example manufacturing process for thermoforming one or more of the first set of raised elements and the second set of raised elements in accordance with aspects herein.

### DETAILED DESCRIPTION

A variety of articles, including footwear, are formed of textiles, which are often made by weaving or interlooping (e.g., knitting) a yarn or a plurality of yarns. In particular, an upper for an article of footwear may be formed from a knitted textile. To increase durability and/or water resistance, non-textile components may be added and secured (e.g., glued or stitched) to the textile. For example, cross-linked polyurethanes, synthetic leather textiles, laminate film layers, and the like can be used as durable covering layers. However, the addition of any extra layer, even a film, reduces the ability of the article of footwear to provide proprioceptive feedback to a wearer's foot, which can be particularly important for articles in certain sporting activities. In an article of footwear for football (also known in other geographical areas as soccer), for example, it may be important for a wearer to be able to feel the ball through the textile to facilitate ball control and handling.

With continued respect to articles of footwear for football, extra layers may also be used to provide a certain level of traction or grip for ball control and handling. In traditional articles of footwear, it may be difficult to fine-tune the amount of traction or grip imparted by the extra layers. For example, too much grip may interfere with the wearer's ability to perform quick touches and ball-handling maneuvers while too little grip impedes the wearer's ability to control the ball. Additionally, when extra layers are used to provide traction or grip, the amount and/or directionality of grip may be generally the same on both the medial and lateral sides of the article of footwear, which fails to address the different functions the medial and lateral sides of the article of footwear perform during wear (e.g., kicking using the medial side of the article of footwear and dribbling using the lateral side of the article of footwear).

At a high level, aspects herein are directed to a knitted upper and articles of footwear that incorporate the same that include raised elements that extend in a z-direction away from an outer surface of the knitted upper. The raised elements comprise a thermoformed network of interlooped yarns. In example aspects, a first set of raised elements extends in a first direction on a lateral side of the knitted upper, and a second set of raised elements extends in a second direction on a medial side of the knitted upper, where the second direction is different from the first direction. More particularly, in example aspects, the first direction may be from a toe area of the article of footwear toward a heel area of the article of footwear (i.e., a longitudinal direction), and the second direction may be from a lower area of the article of footwear toward a throat area of the article of footwear (i.e., a vertical direction). In example aspects, the lower area may comprise an area adjacent (from about 0.5 mm to about 2 cm) to a biteline of the article of footwear.

In example aspects, the thermoformed network of interlooped yarns that form the raised elements imparts a higher coefficient of friction to the raised elements compared to a common, non-thermoformed material, as described more fully below. Thus, by orienting the raised elements differently on the lateral and medial sides of the article of footwear, directional grip may be achieved. As used herein, the term “directional grip” or “direction of grip” relates to the orientation of the raised elements. Because the raised elements have a higher coefficient of friction compared to a non-thermoformed material, the “grip” associated with the raised elements also has a direction or orientation that corresponds to the orientation of the raised elements. For example, on the lateral side of the article of footwear, the direction of grip may be oriented primarily longitudinally (i.e., from a toe area toward a heel area), and on the medial side of the article of footwear, the direction of grip may be oriented primarily vertically (i.e., from a lower area near the biteline of the article of footwear toward a throat area). Imparting different grip directions on the lateral and medial sides of the article of footwear enables the different sides to have, for example, different functions. For example, the longitudinal grip direction on the lateral side of the article of footwear may facilitate the wearer's ability to advance a soccer ball in a forward or backward direction while dribbling. The vertical grip direction on the medial side of the article of footwear may facilitate the wearer's ability to lift and/or curl the ball during kicking.

Additional features of the raised elements such as height in the z-direction and spacing between adjacent raised elements may be adjusted to achieve desired functions. For example, because the raised elements are created using a thermoforming process that functionally locks the knit loops into place and restricts stretch, the flexibility and/or pliability of the knitted upper may be reduced in areas where the raised elements are located. This may be advantageous in certain areas of the article of footwear where stiffer properties may be desired, such as, for example, areas of the article of footwear that experience high amounts of contact (i.e., touch) with a soccer ball. In these areas, the spacing between adjacent raised elements may be reduced to increase the density of raised elements and/or the height in the z-direction of the raised elements may be increased to create more lockdown of the knit structure. However, in other areas of the article of footwear where increased flexibility and/or pliability is desired (e.g., adjacent the throat area and/or the ankle opening), the raised elements may be spaced farther apart and/or the height of the raised elements in the z-direction may be reduced. In another example where additional, non-raised-element areas of the knitted upper are thermoformed and therefore exhibit grip, the raised elements may be useful in minimizing or reducing contact between the soccer ball and the surface of the article of footwear. This may be advantageous in situations where quick, light contact with the soccer ball is needed.

With respect to thermoforming, thermoplastic elastomers have been identified that can be incorporated into polymeric compositions to provide levels of abrasion resistance, traction (which may also be referred to as grip), or both, making these materials suitable for use in articles where abrasion resistance or traction are desirable, e.g., articles of apparel, footwear, and sporting equipment. In many cases, the level of abrasion resistance, traction, or both provided by these polymeric compositions is equivalent to or better than that of standard vulcanized rubber compositions used in the manufacturing of footwear, apparel, and sporting equipment. Unlike vulcanized rubber, due to the thermoplastic nature of these polymeric compositions and their properties in the solid and molten state, it is possible to readily form them into coated yarns that have suitable properties for use in industrial-scale knitting or weaving equipment. These properties result in yarns that can be readily incorporated into various articles, e.g., textiles used in conventional manufacturing processes such as knitting and weaving, as well as industrial-scale processes for making nonwoven textiles. Also, unlike vulcanized rubber, these textiles and articles into which these textiles are incorporated can then, in turn, be thermoformed in a manner that reflows the polymeric composition of the coated yarns and creates an abrasion-resistant or higher-grip surface on the textile or article under conditions that limit damage to other components of the textile or article, such as, for example, other yarns, other textiles, foams, molded resin components, or the like.

In example aspects, the knitted upper may include a first yarn having a first core yarn (also referred to herein as a “core”) and a first coating (also referred to herein as a “coating”). In one aspect, the first yarn may comprise one or more core yarns that may be at least partially coated with a coating, e.g., formed of a grip material. Alternatively, when core yarns are used, each core yarn may form a twisted yarn, and the twisted yarn may be at least partially coated with the grip material.

In one instance, the coating of a core yarn can be a thermoplastic elastomer. In example aspects, the thermoplastic elastomer may comprise a thermoplastic polyurethane or a styrene ethylene/butylene styrene (SEBS). In addition, the core and the coating can be formed of different materials. For example, the core can be formed of a polymer and/or an elastomer that is different than a thermoplastic elastomer of the coating. The core and the coating can be formed to have different material properties, e.g., elasticity, melting temperature, and/or decomposition temperature, and/or other different properties. For example, the coating may have a first material composition (which may include a thermoplastic elastomer) having a lower melting temperature than the melting temperature of a second material composition forming the core. The second material forming the core may exclude the thermoplastic elastomer that is present in the coating.

In addition to a first yarn as described above, the knitted upper can include a second yarn or additional yarns that are different than the first yarn. In example aspects, the ratio of the first yarn to the second or additional yarns on an outer surface of the article of footwear may be about 50:50 or about 60:40. For example, the first yarn and the second or additional yarns can differ through being formed from different materials, e.g., thermoforming materials or non-thermoforming materials, can differ through having different material properties, e.g., diameters, densities, deniers, tenacities, elasticities, tensile strengths, melting or decomposition temperatures, static/dynamic coefficients of friction, and/or other material properties, and/or can differ through having different constructions, e.g., a core/sheath construction or a singular or unified construction without a distinct core and sheath. The second yarn may have a material composition that excludes the thermoplastic elastomer in the coating and that has a greater melting temperature than the composition of the coating. Due at least in part to the material of the first yarn and the thermoforming process, the raised elements may have a higher coefficient of friction compared to textiles that do not include the first yarn. The higher coefficient of friction enables the raised elements to “grip” a soccer ball leading to improved ball control.

When the knitted upper is thermoformed, at least some of the first coating flows and occupies at least a portion of spaces between courses of the first yarn, courses of the first core yarn, and/or courses of the second or additional yarns. This arrangement can advantageously integrate 360-degree ball control directly into the knitted upper without the need for laminated skins, streamlining the surface into a single functional layer. This single functional layer can help bring the wearer closer to the ball by removing a layer therefrom, which thereby increases proprioceptive feedback to the wearer and further improves ball control. Additionally, not including a laminated skin improves manufacturing efficiency by reducing post-knitting processes, improves weatherization, and reduces weight.

Aspects of this disclosure may further include methods of manufacturing a knitted upper that may be incorporated into an article of footwear. In a first example manufacturing method or process, at least the first yarn is knitted to form the knitted upper, where the knitted upper includes a first surface and an opposite second surface. The first surface of the knitted upper may be positioned adjacent to a surface of a first mold plate that includes one or more cavities or depressions that correspond to a desired pattern of raised elements. A second mold plate is positioned adjacent the second surface of the knitted upper, and one or more of heat and pressure are applied to the first mold plate and/or the second mold plate. Subsequent to the application of heat and/or pressure, the cavities of the first mold plate are at least partially filled with a thermoformed network of interlooped yarns to form the first and second sets of raised elements. When the knitted upper is incorporated into an article of footwear, the first surface forms an outer surface of the article of footwear.

In a second example manufacturing method or process, the second surface of the knitted upper is positioned adjacent a first mold plate that includes projections that correspond to a desired pattern of raised elements. A pliable, heat-resistant pad, such as a silicone pad, is positioned adjacent the first surface of the knitted upper, and one or more of heat and pressure are applied to the pad-knitted upper-mold plate assembly. The projections on the first mold plate push a thermoformed network of interlooped yarns into the pliable, heat-resistant pad to form the first and second sets of raised elements. Raised elements formed using the second method may have a less defined shape compared to the raised elements formed using the first method due to the absence of a rigid mold plate. As well, in example aspects, the raised elements may not exhibit the same degree of thermoforming compared to the first method due to possible dissipation of the heat and/or pressure with use of the pliable pad. Because of this, the raised elements may retain more of a knit structure in the second method compared to the first method. In example aspects, the knit structure in the raised elements may provide an additional level of grip or traction compared to raised elements that have been completely thermoformed.

As used herein, the term “article of footwear” generally includes an upper and a sole structure. The upper is secured to the sole structure and forms a void within the article of footwear for comfortably and securely receiving a foot. As used herein, the term “upper” refers to a footwear component that extends over the instep and toe areas of the foot, along the medial and lateral sides of the foot, and around the heel area of the foot to form a void for receiving a wearer's foot. Illustrative, non-limiting examples of uppers may include uppers incorporated into a basketball shoe, a biking shoe, a cross-training shoe, a global football (soccer) shoe, an American football shoe, a bowling shoe, a golf shoe, a hiking shoe, a ski or snowboarding boot, a tennis shoe, a running shoe, and a walking shoe. Further, in other aspects, the upper may also be incorporated into a non-athletic shoe, such as a dress shoe, a loafer, and a sandal. Accordingly, the concepts disclosed with respect to articles of footwear apply to a wide variety of footwear types.

As used herein, the article of footwear and/or the knitted upper may be divided into different general regions. A forefoot region generally includes portions of the article of footwear and/or upper that corresponds to the toes and joints connecting the metatarsals with the phalanges. A midfoot region generally includes portions of the article of footwear and/or upper corresponding with an arch area and an instep area of the foot. A heel region generally corresponds with rear portions of the foot including the calcaneus bone. The upper and article of footwear described herein may include a lateral side, which corresponds with an outside area of the foot (i.e., the surface that faces away from the other foot), and a medial side, which corresponds with an inside area of the foot (i.e., the surface that faces toward the other foot). The different regions and sides described above are intended to represent general areas of footwear to aid in the following discussion and are not intended to demarcate precise areas. The different regions and sides may be applied to the article of footwear as a whole, to the upper, and to the sole structure.

The term “outer” as used herein means a surface of the upper or article of footwear that faces the external environment. In some aspects, the outer surface may mean the outermost surface of the upper or article of footwear. The term “interior” as used herein means a surface of the upper or article of footwear that faces a void for receiving the wearer's foot. In some aspects, the interior surface may mean the innermost surface of the upper or article of footwear.

The term “knitted component” or “knitted upper” refers to a textile piece that is formed from at least one yarn that is manipulated (e.g., with a knitting machine) to form a plurality of intermeshed loops that define courses and wales. The term “course,” as used herein, refers to a predominantly horizontal row of knit loops (in an upright textile as-knit) that are produced by adjacent needles during the same knitting cycle. The course may comprise one or more stitch types, such as a knit stitch, a held stitch, a float stitch, a tuck stitch, a transfer stitch, a rib stitch, and the like, as these terms are known in the art of knitting. The term “knit stitch,” as used herein, refers to the basic stitch type where the yarn is cleared from the needle after pulling a loop of the yarn from the back to the front of the textile through a previous stitch. The term “wale,” as used herein, is a predominantly vertical column of intermeshed or interlooped knit loops, generally produced by the same needle at successive (but not necessarily all) courses or knitting cycles. Knitted components described herein may include weft-knitted or warp-knitted components.

The term “integrally knit,” as used herein, may mean a knit textile having a yarn from one or more knitted courses in one area being interlooped with one or more knitted courses of another area. The interlooping may be through a simple knit stitch, a tuck stitch, a held stitch, a float or miss stitch, and the like. In this way, areas that are integrally knit together have a seamless transition.

As used herein, the term “double-knit construction” refers to a textile or textile portion knit on a machine with two sets of needles in two needle beds or cylinders. Some aspects herein contemplate the machine comprising a weft-knit (flat-knit) machine. The term “bed” is typically used when describing flat-knit machines. However, it should be understood that aspects herein may relate to warp-knitted components as well. To describe it in a different way, the term double-knit construction means a textile having front courses formed on a first needle bed and back courses formed on a second needle bed. The front courses of a double-knit constructed textile are courses of interlooped stitches forming a front layer of the textile, and the back courses are courses of interlooped stitches forming a back layer of the textile such that the front layer and the back layer of the textile may be formed at substantially the same time. As used herein, the term “front layer” or “first surface” refers to a textile layer that is configured to face externally when the article incorporating the textile, such as the knitted upper, is worn. As used herein, the term “first surface” means the surface of the article of footwear that does not include raised elements and is generally planar along an x, y plane. In this aspect, the raised elements are described as extending in a z-direction with respect to the first surface of the upper. The term “back layer” or “second surface” refers to a textile layer that is configured to be facing a skin surface of the wearer when the article of footwear is worn.

Additionally, there are various measurements provided herein. Unless indicated otherwise, all measurements provided herein are taken when the upper and/or article of footwear is at standard ambient temperature and pressure (298.15 K and 100 kPa) and is in a resting (non-tensioned) state. Unless indicated otherwise, the term “about” or “substantially” with respect to a measurement means within +10% of the indicated value.

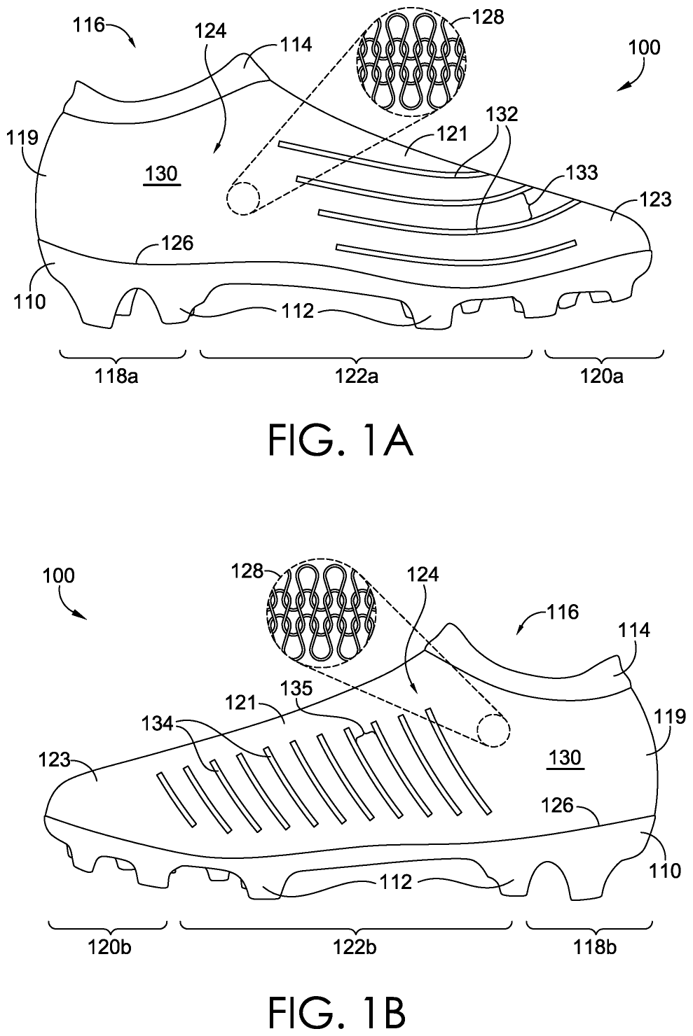

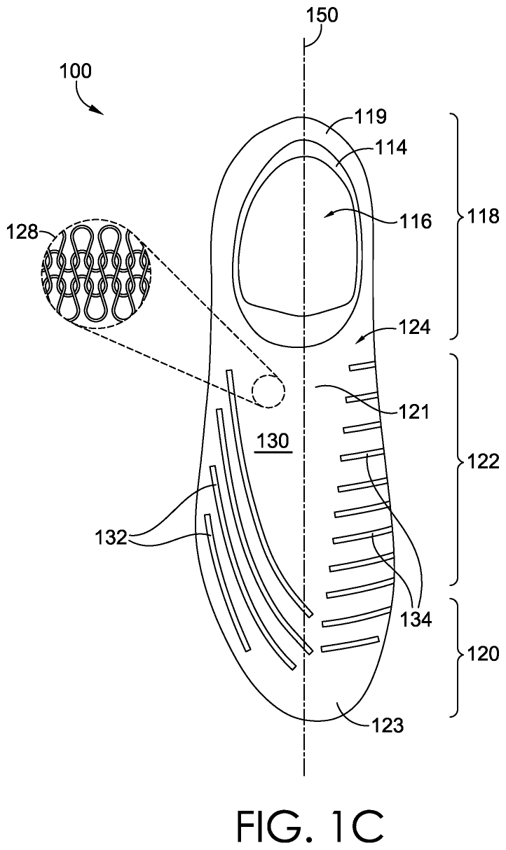

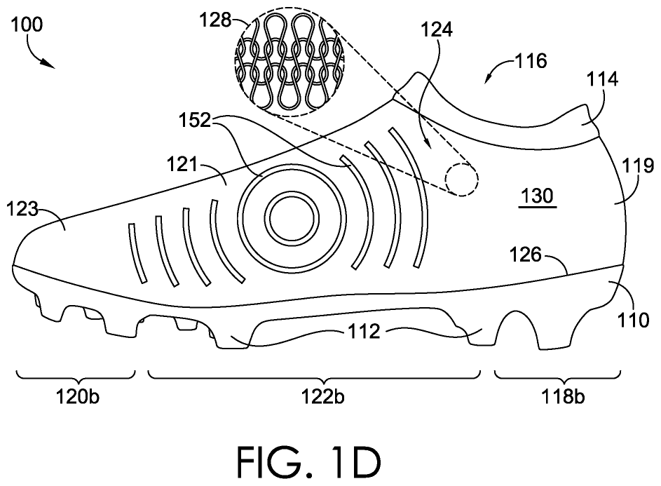

FIG. 1A depicts a view of a lateral side of an article of footwear 100, FIG. 1B depicts a view of a medial side of the article of footwear 100, and FIG. 1C depicts a top-down view of the article of footwear 100. As shown in FIGS. 1A-1C, the article of footwear 100 is intended to be used with a right foot; however, it should be understood that the following discussion may also apply to a mirror image of the article of footwear 100 that is intended for use with a left foot. Although an article of footwear is shown, it should be understood that other articles of wear are also contemplated by the present disclosure, including but not limited to apparel (e.g., shirts, jerseys, pants, shorts, gloves, glasses, socks, hats, caps, jackets, undergarments, or other apparel) and containers (e.g., backpacks, bags, or other containers).

The article of footwear 100 includes an ankle collar 114 that defines an ankle opening 116 for receiving a wearer's foot, a heel area 119, a toe area 123, and a throat area 121. The article of footwear 100 further includes a lateral heel region 118a, a medial heel region 118b, a lateral forefoot region 120a, a medial forefoot region 120b, a lateral midfoot region 122a, and a medial midfoot region 122b. Although not shown, the article of footwear 100 may optionally include a tongue and eyestays adapted to receive a lace.

The article of footwear 100 additionally includes a sole structure 110 and an upper 124. The sole structure 110 is secured to the upper 124 at a biteline 126, and the sole structure 110 extends between a wearer's foot and the ground when the article of footwear 100 is worn. The sole structure 110 may optionally include a plurality of ground-engaging cleats 112. The upper 124 generally defines a void within the upper 124 for receiving and securing a wearer's foot relative to the sole structure 110. Surfaces of the void within the upper 124 are shaped to accommodate the foot and may extend over the instep and toe areas of the foot, along the medial and lateral sides of the foot, under the foot, and around the heel area of the foot.

In example aspects, at least a portion of the upper 124 may be formed from at least one knitted component 128, as indicated by the knit loops. The knitted component 128 may be formed by a weft-knitting process on a flat-knitting machine, or it may be formed by a warp-knitting process, for example. The knitted component 128 may be formed as a single, integral one-piece element during a knitting process, such as weft knitting, warp knitting, or any other suitable knitting process. In the example depicted in FIGS. 1A-1C, the knitted component 128 forms an outer sheath of the upper 124, forming at least an outer surface of the lateral midfoot region 122a, the medial midfoot region 122b, the lateral and medial forefoot regions 120a and 120b, and at least part of the throat area 121 of the upper 124. In some aspects, the knitted component 128 further forms an interior surface of the upper 124 and may further form an outer surface of the lateral heel region 118a and the medial heel region 118b.

Although not shown, the upper 124 may include additional components, which may be knit, woven, nonwoven, or another type of textile. The additional components may form, for example, at least part of the heel area 119 and/or the ankle collar 114. The additional components may be a single textile component or may be formed of multiple textile components secured together. Further, in aspects, the additional components may be integrally knitted with the knitted component 128. Alternatively, the additional components may be secured to the knitted component 128 via at least one of stitching, bonding, or another attachment method.

The knitted component 128 may include one or more different types of yarns for imparting different functionality. For example, the knitted component 128 may include a first yarn and a second or additional yarns. The first yarn (also referred to as first coated yarn or coated yarns herein) includes a first core yarn and a first coating providing a first set of properties to the first yarn. The second or additional yarns may have a different material composition and/or different properties than the first yarn. For example, the second or additional yarns may comprise high-tenacity yarns having a tenacity of, for example, about 5 grams/denier or greater to impart abrasion resistance and durability to the knitted component 128.

Further, within the first yarn, the first core yarn and the first coating may have different material compositions to provide different properties. For example, as described herein, the first coating may comprise a low-processing temperature polymeric composition while the first core yarn may comprise a high-processing temperature polymeric composition such that the first coating may melt or deform at a temperature that leaves the core yarn intact. In one aspect, the deformation temperature of the polymeric composition of the first core yarn of the first yarn is at least 20 degrees Celsius higher than the melting temperature of the polymeric composition of the first coating, e.g., through use of a polymeric composition comprising a thermoplastic composition. This allows the core yarn to be coated by the coating when the coating is in a molten state.

The first core yarn of the first yarn may comprise a monofilament or multifilament yarn, such as a commercially available polyester or polyamide yarn having properties (such as denier and tenacity) sufficient for the yarn to be manipulated by industrial-scale knitting equipment. Further, the core yarn may be based on natural or man-made fibers including polyester, high-tenacity polyester, polyamide yarns, metal yarns, stretch yarns, carbon yarns, glass yarns, polyethylene or polyolefin yarns, bi-component yarns, Polytetrafluoroethylene (“PTFE”) yarns, ultra-high-molecular-weight polyethylene (“UHMWPE”) yarns, liquid crystal polymer yarns, specialty decorative yarns, reflective yarns, or a multi-component yarn comprising one or more of the yarns. In example aspects, the core yarn comprises a thermoplastic material comprising a polyester.

In various aspects, the first core yarn may be coated by any method known in the art. In one aspect, the polymeric compositions for the first coating disclosed herein are suitable for manufacturing by pultrusion and/or pulling the yarns through baths of liquid polymeric materials. In still another aspect, regardless of coating process, sufficient coating material is provided on the first yarn such that, when knit alone or with one or more other yarns in various configurations and subsequently thermoformed and allowed to reflow and resolidify, the coating material (e.g., polymeric composition comprising a thermoplastic elastomer) forms a structure with an adequate concentration of the coating material on one or more surfaces and/or within the first core yarn, depending upon the placement of the first yarn within the knit structure.

The first coating of the first yarn comprises a polymeric composition that comprises a thermoplastic composition that comprises a thermoplastic elastomer. While it is possible to extrude a polymeric composition that is a thermoplastic elastomeric composition and form fibers, filaments, yarns, or films directly from the polymeric composition due to its elastomeric properties, these forms of the polymeric composition will have high levels of stretch and heat shrinkage. This means the fibers, filaments, yarns, or films may tend to stretch around machine guides rather than slide past them, and may tend to shrink at the temperatures commonly encountered in industrial-scale knitting and weaving equipment. However, by applying the polymeric composition as a coating onto a core yarn that is suitable to be mechanically manipulated, the resulting coated first yarn retains the tenacity and stretch resistance of the core yarn, while also providing an external-facing surface having superior traction and abrasion resistance provided by the polymeric composition of the coating due to its elastomeric properties. For example, it has been found that a 150-denier core yarn having a tensile strength of at least 1 kilogram-force at break, less than 20 percent strain to break, and a heat shrink of less than 20 percent may be coated with the polymeric composition to a nominal average outer diameter of up to about 1.0 millimeter and still retain its ability to be knit or inlaid using commercial flat-knitting equipment. Due to the ability to use this yarn on industrial-scale equipment, this first yarn may also allow for new methods of manufacturing that will allow for different placements of the polymeric composition within textiles and articles comprising the textiles at greater levels of specificity in terms of both location and amount as compared to conventional manufacturing processes.

Additionally, the thermoplastic nature of the polymeric composition makes it possible to melt the composition and use it to coat the first core yarn when the melting temperature of the polymeric composition is sufficiently lower than the deformation temperature of the first core yarn, as well as to subsequently thermoform the knitted component 128 to create a thermoformed network comprising both the first core yarn and the reflowed and resolidified polymeric composition, thereby consolidating, bridging, and/or interconnecting the first core yarn. In one aspect, the thermoplastic elastomer(s) of the polymeric composition of the coating has a glass transition temperature(s) below minus 20 degrees Celsius, which allows the thermoplastic elastomer(s) present in the polymeric composition to be in their “rubbery” state, even when the knitted component 128 is used in cold environments. In another aspect, the melting temperature of the polymeric composition of the coating is at least 100 degrees Celsius, which may help ensure that the polymeric composition will not melt when the knitted component 128 is shipped or stored under hot conditions. In another aspect, the melting temperature of the polymeric composition of the coating is at least 130 degrees Celsius, which helps ensure that the polymeric composition will not melt when the knitted component 128 is subjected to conditions often encountered by textiles during the manufacturing processes for articles of footwear, apparel, or sporting equipment, such as steaming processes. In another aspect, the melting temperature of the polymeric composition of the coating is at less than 170 degrees Celsius, which helps ensure that the knitted component 128 may be thermoformed at temperatures that do not negatively impact other textiles or components that may form part of the upper 124. In another aspect, the enthalpy of the melting of the thermoplastic elastomer(s) of the polymeric composition of the coating may be less than about 30 Joules per gram or 25 Joules per gram, which means that, during the thermoforming process, less heat and a shorter heating time is required to fully melt the polymeric composition and achieve good flow of the molten polymeric composition to better consolidate, bridge, and/or interconnect the network of yarns in the knitted component 128. In another aspect, the recrystallization temperature of the thermoplastic elastomer(s) of the polymeric composition of the coating may be above 60 degrees Celsius or above 95 degrees Celsius, which may promote rapid resolidification of the polymeric composition after thermoforming, which may reduce the amount of time required to cool the textile after thermoforming and may avoid the need to provide active cooling of the textile, thereby reducing cycle time and reducing energy consumption.

Because the knitted component 128 also includes the second or additional yarns in addition to the first yarn (i.e., the coated yarn), the thermoformed network of yarns (i.e., the core yarn from the first yarn and the second or additional yarns) is consolidated, bridged, and/or interconnected by the reflowed and resolidified polymeric composition. The presence of the reflowed and resolidified polymeric composition may serve one or more functions within the thermoformed textile, such as controlling the level of stretch within the entire knitted component 128 or just within a region thereof, forming a skin having high abrasion resistance and/or traction across an entire surface of the knitted component 128 or just within a region thereof, improving water resistance of an entire surface of the knitted component 128 or just within a region thereof, or bonding all of the knitted component 128 or just a region thereof to a substrate.

Use of the first yarn in the knitted component 128 may also reduce the number of different materials required to form the article of footwear 100. The coating of the first yarn, when thermoformed, may form a skin on a surface of the knitted component 128. Alternatively or additionally, the coating of the first yarn, when thermoformed, may act as a bonding agent, either to bond yarns together within the knitted component 128, or to bond other elements to a surface of the knitted component 128. The use of the thermoformed knitted component 128 described herein may replace one or more of the separate elements conventionally added to increase abrasion resistance or create traction, reducing waste and simplifying manufacturing processes while improving recyclability of the articles. Additionally, creating these properties within the knit structure of the knitted component 128, rather than as an additional layer, helps the knitted component 128 conform to the shape of the wearer's foot and enables more proprioceptive feedback, such as when handling a football or soccer ball. Note that other balls may be used with the articles of footwear described herein without departing from the scope of the technology herein.

This thermoformed network of the thermoformed textile may form an outer surface of the upper 124, such as the first surface 130 of the knitted component 128 in FIGS. 1A-1C. Unexpectedly, the thermoformed network created by thermoforming the textiles has superior properties for ball contact, in that the properties of the thermoformed network may be equal to or superior to those of kangaroo skin leather in terms of the spin rate imparted to the ball by the upper when kicking the ball. For example, it has been found that using polymeric compositions having a Durometer Hardness (Shore A) of about 65 to about 85 results in uppers with improved ball spin rates. Uppers comprising the textiles described herein have also been found to be equivalent to or superior to those of synthetic leather or knit uppers coated with a skin in terms of traction under wet and dry conditions.

In example aspects, the knitted component 128 may be thermoformed to create raised elements as described above with respect to the example thermoforming methods. For example, with respect to FIG. 1A, the upper 124 includes a first set of raised elements 132 on the lateral side of the article of footwear 100 that extend in a first direction. In example aspects, the first direction is from the toe area 123 toward the heel area 119. Each raised element of the first set of raised elements 132 extends in a z-direction away from the first surface 130 of the upper 124. In example aspects, the raised elements of the first set of raised elements 132 may have a maximum height in the z-direction from about 0.1 millimeters to about 1.5 millimeters, from about 0.15 millimeters to about 1.2 millimeters, or from about 0.2 millimeters to about 0.9 millimeters. As further described below, in example aspects, the raised elements of the first set of raised elements 132 may have different heights. For example, a first raised element may have a maximum height of about 0.9 millimeters, and a second raised element may have a maximum height of about 0.5 millimeters. This is an illustrative example and different heights are contemplated herein.

Aspects herein further contemplate that a particular raised element of the first set of raised elements 132 may have a varying height as it extends from a first terminal end of the raised element to an opposite second terminal end of the raised element. For example, at each of the first and second terminal ends of the raised element, the raised element may have a minimum height of from about 0.1 millimeters to about 0.2 millimeters in the z-direction. At a midpoint of the raised element (i.e., at a location approximately halfway between the first terminal end and the second terminal end), the raised element may have a maximum height of about 0.4 millimeters to about 1.0 millimeters, or about 0.5 millimeters to about 0.9 millimeters. In line with this, a particular raised element of the first set of raised elements 132 may have a varying width as the raised element extends from the first terminal end to the second terminal end of the raised element. For example, a width of a raised element adjacent to either the first terminal end and/or the second terminal end may be from about 0.1 millimeters to about 0.5 millimeters, while a maximum width of a particular raised element, which may be at a midpoint or another position between the first and second terminal ends, may be from about 0.6 millimeters to about 2 millimeters, or from about 0.75 millimeters to about 1.5 millimeters.

In example aspects, each raised element of the first set of raised elements 132 is separated from an adjacent raised element by an intervening segment of the knitted component 128 that does not include raised elements, such as segment 133. In example aspects, the intervening segments 133 may have a width from about 1 millimeters to about 5 millimeters, or from about 2 millimeters to about 3 millimeters. In example aspects, the intervening segments 133 may also comprise the thermoformed network of interlooped yarns or the intervening segments 133 may comprise a non-thermoformed material. The spacing between adjacent raised elements of the first set of raised elements 132 may be optimized to provide a desired level of flexibility and/or pliability in the area where the first set of raised elements 132 is located. For example, when spacing between adjacent raised elements is reduced, flexibility may also be reduced. This may be desirable when a stiffer surface is desired. Conversely, when spacing between adjacent raised elements is increased, flexibility may also be increased. This may be desirable when a more pliable surface is desired.

In example aspects, the first set of raised elements 132 may limit contact of, for example, a ball with the first surface 130 of the knitted component 128 in the areas where the first set of raised elements 132 is located. In example aspects, the average dry static coefficient of friction for the first set of raised elements 132 may be from about 0.6 to about 0.8, from about 0.65 to about 0.75, or about 0.69. The average dry dynamic coefficient of friction of the first set of raised elements 132 may be from about 0.4 to about 0.6, from about 0.45 to about 0.55, or about 0.49. The average wet static coefficient of friction for the first set of raised elements 132 may be from about 0.4 to about 0.6, from about 0.45 to about 0.55, or about 0.54. The average wet dynamic coefficient of friction for the first set of raised elements 132 may be from about 0.25 to about 0.45, from about 0.3 to about 0.4, or about 0.35. The coefficients of friction described above are measured in one direction with respect to the raised elements. Stated differently, it is contemplated herein that the coefficient of friction values may be different when measured in an opposite direction with respect to the raised elements.

As described above, in example aspects, the first surface 130 of the knitted component 128 may also comprise a thermoformed network of interlooped yarns and, as such, may exhibit a higher coefficient compared to a knitted component that is not thermoformed. Although this is desirable for some aspects of ball control, the first set of raised elements 132 may be more suitable for quick touches with the soccer ball as surface contact is minimized and the contact time between the ball and the first surface 130 may be reduced.

As depicted, the first set of raised elements 132 extends longitudinally from the toe area 123 toward the heel area 119. In example aspects, the first set of raised elements 132 is primarily located in the lateral forefoot region 120a and extends to and/or into the lateral midfoot region 122a. In example aspects, the lateral heel region 118a does not include raised elements. As depicted in the top-down view of FIG. 1C, in example aspects, the first set of raised elements 132 may extend across a longitudinal midline 150 that extends from the toe area 123 to the heel area 119 and generally divides the article of footwear 100 into medial and lateral sides. Thus, in this aspect, at least a portion of the first set of raised elements 132 may extend into the medial forefoot region 120b. In a further example aspect, which is not shown, the first set of raised elements 132 may extend across the longitudinal midline 150 and be continuous with the second set of raised elements 132 such that a particular raised element may be located in the lateral midfoot region 122a, the lateral forefoot region 120a, the medial forefoot region 120b, and the medial midfoot region 122b.

The location, density, and/or height of the first set of raised elements 132 may be based on contact maps that indicate areas of frequent contact between a wearer's foot and a ball, such as a soccer ball. The longitudinal orientation of the first set of raised elements 132 imparts a longitudinal grip feature to portions of the lateral side of the article of footwear 100. The longitudinal grip may be ideal for advancing the ball in a forward or backward direction during, for example, dribbling using the lateral side of the wearer's foot.

The pattern of the first set of raised elements 132 depicted in FIG. 1A is illustrative. For example, although depicted as generally continuous and linear, aspects herein contemplate other patterns for the first set of raised elements 132 such as discontinuous segments, sinusoidal, zigzag, curvilinear, and the like. In these examples, including, for example, discontinuous segments, aspects herein still contemplate that the discontinuous segments are oriented in a generally horizontal, longitudinal direction (e.g., from a toe area toward a heel area). Moreover, although four raised elements are depicted, aspects herein contemplate a greater number or a fewer number of raised elements. In addition, the length of the individual elements is illustrative, and aspects herein contemplate longer and shorter lengths. The spacing between adjacent raised elements is illustrative as well, and aspects herein contemplate raised elements that are spaced closer together or farther apart. Any and all aspects, and any variation thereof, are contemplated as being within aspects herein.

In FIG. 1B, the upper 124 includes a second set of raised elements 134 on the medial side of the article of footwear 100 that extends in a second direction different from the first direction. In example aspects, the first set of raised elements 132 forms a first pattern on the lateral side of the article of footwear 100, and the second set of raised elements 134 forms a second pattern on the medial side of the article of footwear 100 where the second pattern is different from the first pattern. In example aspects, the second direction is from an area adjacent the biteline 126 toward the throat area 121. In example aspects, one or more of the second set of raised elements 134 may be curved slightly such that, for example, an apex of curvature extends toward the toe area 123. In example aspects, the apex of curvature may be at an approximate midpoint of the respective raised elements. Each raised element of the second set of raised elements 134 extends in a z-direction away from the first surface 130 of the upper 124. In example aspects, the maximum height in the z-direction for the second set of raised elements 134 may be from about 0.1 millimeters to about 1.5 millimeters, from about 0.15 millimeters to about 1.2 millimeters, or from about 0.2 millimeters to about 0.9 millimeters. As further described below, in example aspects, the raised elements of the second set of raised elements 134 may have different heights. For example, a first raised element may have a maximum height of about 0.9 millimeters, and a second raised element may have a maximum height of about 0.5 millimeters. This is an illustrative example, and different heights are contemplated herein.

Aspects herein further contemplate that a particular raised element of the second set of raised elements 134 may have a varying height as it extends from a first terminal end of the raised element to an opposite second terminal end of the raised element. For example, at each of the first and second terminal ends of the raised element, the raised element may have a minimum height of about 0.1 millimeters to about 0.2 millimeters in the z-direction. At a midpoint of the raised element (i.e., at a location approximately halfway between the first terminal end and the second terminal end), the raised element may have a maximum height of about 0.4 millimeters to about 1.0 millimeters, or about 0.5 millimeters to about 0.9 millimeters. In line with this, a particular raised element of the second set of raised elements 134 may have a varying width as the raised element extends from the first terminal end to the second terminal end of the raised element. For example, a width of the raised element adjacent to either the first terminal end and/or the second terminal end may be from about 0.1 millimeters to about 0.5 millimeters, while a maximum width of a particular raised element, which may be at a midpoint or another location between the first and second terminal ends, may be from about 0.6 millimeters to about 2 millimeters, or from about 0.75 millimeters to about 1.5 millimeters.

In example aspects, each raised element in the second set of raised elements 134 is separated from an adjacent raised element by an intervening segment of the knitted component 128 that does not include raised elements, such as segment 135. In example aspects, the intervening segments 135 may have a width from about 1 millimeters to about 5 millimeters, or from about 2 millimeters to about 3 millimeters. The intervening segments 135 may also comprise the thermoformed network of interlooped yarns or the intervening segments 135 may comprise a non-thermoformed material. Also similar to the first set of raised elements 132, the spacing between adjacent raised elements of the second set of raised elements 134 may be optimized to provide a desired level of flexibility and/or pliability in the area where the second set of raised elements 134 is located. The second set of raised elements 134 also limits contact of, for example, a ball with the first surface 130 of the knitted component 128 in the areas where the second set of raised elements 134 is located, which may help to limit or reduce the contact time between the ball and the first surface 130.

As depicted, the second set of raised elements 134 extends generally vertically from a lower area of the upper 124 near the biteline 126 toward the throat area 121. In example aspects, the vertical orientation of the second set of raised elements 134 may be generally orthogonal (e.g., from about 80 degrees to about 100 degrees) to the first set of raised elements 132. In example aspects, the average dry static coefficient of friction for the second set of raised elements 134 may be from about 0.6 to about 0.8, from about 0.65 to about 0.75, or about 0.7. The average dry dynamic coefficient of friction of the second set of raised elements 134 may be from about 0.4 to about 0.6, from about 0.45 to about 0.55, or about 0.5. The average wet static coefficient of friction for the second set of raised elements 134 may be from about 0.4 to about 0.6, from about 0.45 to about 0.55, or about 0.54. The average wet dynamic coefficient of friction for the second set of raised elements 134 may be from about 0.25 to about 0.45, from about 0.3 to about 0.4, or about 0.39. The coefficients of friction described above are measured in one direction with respect to the raised elements. Stated differently, it is contemplated herein that the coefficient of friction values may be different when measured in an opposite direction with respect to the raised elements.

In example aspects, the second set of raised elements 132 is primarily located in the medial forefoot region 120b and the medial midfoot region 122b. In example aspects, the medial heel region 118b does not include raised elements. The location, density, and/or height of the second set of raised elements 134 may also be based on contact maps that indicate areas of frequent contact between a wearer's foot and a ball such as a soccer ball. The vertical orientation of the second set of raised elements 134 imparts a vertical grip feature to portions of the medial side of the article of footwear 100. The vertical grip may be ideal for lifting and/or curling the ball when kicked, an action commonly completed using the medial side of the wearer's foot. In further aspects where one or more of the second set of raised elements 134 is curved, the curve may provide an additional level of ball control due to the spherical nature of the ball. For example, the curve in the raised elements may increase the amount of contact between the article of footwear 100 and the ball as the ball rolls along the medial side of the article of footwear 100.

The pattern of the second set of raised elements 134 depicted in FIG. 1B is illustrative. For example, although depicted as generally continuous and linear, aspects herein contemplate other patterns for the second set of raised elements 134 such as discontinuous segments, sinusoidal, zigzag, curvilinear, and the like. When the second set of raised elements 134 includes discontinuous segments, aspects herein contemplate that the segments still have a generally vertical orientation (e.g., from a lower area toward a throat area). FIG. 1D illustrates another example pattern for the second set of raised elements (referenced in FIG. 1D by the numeral 152). The second set of raised elements 152 in FIG. 1D includes raised elements that generally extend vertically from a lower area (e.g., an area near the biteline 126) to the throat area 121 of the article of footwear 100. Additionally, the second set of raised elements 152 includes one or more circular raised elements with more linear raised elements that collectively form a bullseye type pattern extending across the medial forefoot region 120b and the medial midfoot region 122b. The pattern shown in FIG. 1D may also be based on contact maps that indicate areas of frequent contact between a wearer's foot and a ball such as a soccer ball.

The number of raised elements within in the second set of raised elements 134 shown in FIGS. 1B and 1D is illustrative, and aspects herein contemplate a greater number or a fewer number of raised elements. The spacing between adjacent raised elements is illustrative, and aspects herein contemplate raised elements that are spaced closer together or farther away. In addition, the length of the individual raised elements is illustrative, and aspects herein contemplate longer and shorter lengths. Any and all aspects, and any variation thereof, are contemplated as being within aspects herein.

Thus, as shown and described, the article of footwear 100 may include raised elements on each of the lateral and medial sides that help to reduce contact of, for example, a soccer ball with the first surface 130 of the article of footwear 100, making them useful for quick touch ball control and handling. Moreover, the raised elements on each of the medial and lateral sides are oriented differently to provide different grip directions suitable for the particular side of the shoe. As described, the longitudinal grip direction imparted by the first set of raised elements 132 on the lateral side of the article of footwear 100 may facilitate advancement of a ball in a forward or backward direction during quick touch dribbling. The vertical grip direction imparted by the second set of raised elements 134 or 152 on the medial side of the article of footwear 100 may facilitate the lifting and/or curling of a ball during kicking.

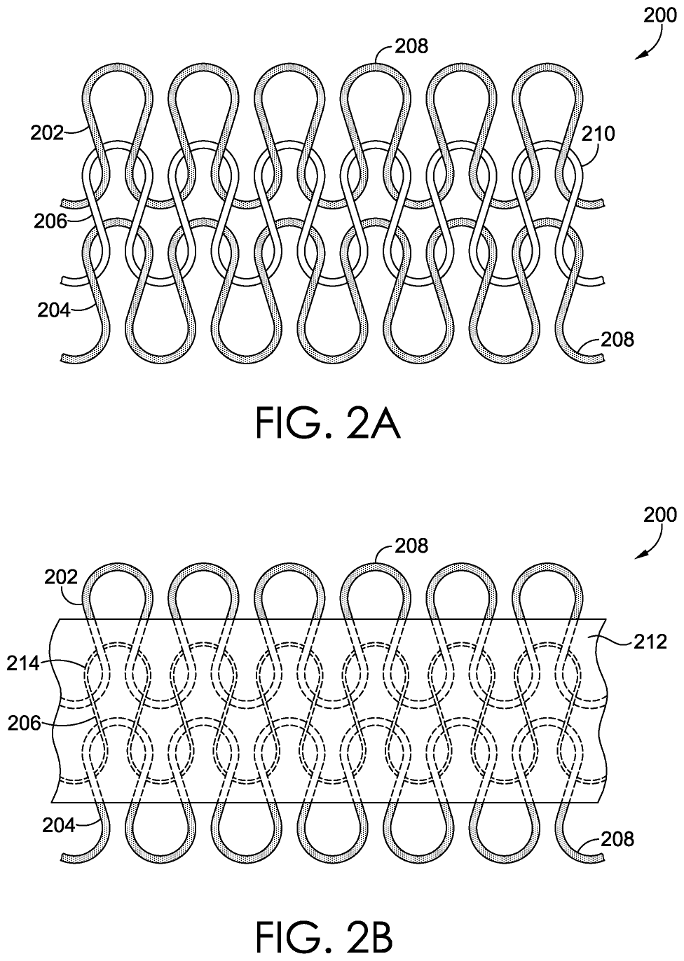

FIG. 2A schematically depicts a portion 200 of an example knitted component, which may be the knitted component 128 of FIGS. 1A-C, prior to a thermoforming process. The portion 200 includes interconnected courses of a first yarn 210, which may be the first coated yarn described herein, and a second yarn 208, which may be the second yarn described with respect to FIGS. 1A-C (i.e., a high-tenacity yarn). The portion 200 includes a first course 202 and a second course 204 having the second yarn 208, and a third course 206 of the first yarn 210. In such an aspect, the third course 206 of loops of the first yarn 210 may be interconnected (e.g., interlooped) to the first course 202 and the second course 204 having the second yarn 208.

FIG. 2B depicts the portion 200 after being exposed to a thermoforming process. As can be seen by comparing FIGS. 2A and 2B, the first yarn 210 that comprises a thermoplastic polymeric composition as described herein was thermoformed from a solid yarn structure into a melted yarn component 212, with a core yarn 214 of the first yarn 210 still remaining in its interlooped configuration. In certain aspects, the heating step of the thermoforming process at least partly causes the coating in the first yarn 210 to melt and flow and then subsequently solidify by the completion of the thermoforming process into the melted yarn component 212. This melted yarn component 212 is the coating surrounding the core yarn 214 of the first yarn 210 after that coating is melted, flowed, and resolidified.

The melted yarn component 212 in FIG. 2B is depicted as contacting and at least partially surrounding the core yarn 214 of the first yarn 210 and contacting and at least partially surrounding a portion of the second yarn 208 at least on the portions of the first course 202 and the second course 204 that interloop with or are proximate to the third course 206 forming a thermoformed network of interlooped yarns. However, the melted yarn component 212 may be thermoformed to spread to a greater extent or a lesser extent on the external-facing surface of the textile than is depicted in FIG. 2B without departing from the subject matter described herein. For example, the melted yarn component 212 in FIG. 2B may be formed by softening, partially melting, or fully melting the coating of the first yarn 210 while at least the core yarn 214 retains its solid structure. In one example, the coating of the first yarn 210 may be softened so that portions of the coating may be fused with adjacent other portions of the first yarn 210 as well as portions of the second yarn 208 within interlooped courses. In another, the coating may be partially melted so that the melted material of the coating may be reflowed and resolidified between adjacent structures within the knitted component to form the melted yarn component 212. In this way, the partially melted coating may fuse together adjacent portions of the first yarn 210, which comprises the core yarn 214 and remaining (non-melted) portions of the coating, as well as fusing to portions of the second yarn 208. In another example, the coating may be fully melted, reflowed and solidified so that the resolidified coating fuses together portions of the remaining core yarn 214 and the second yarn 208.

The areas with the melted yarn component 212 created from thermoforming may have increased abrasion resistance, traction and/or grip, and increased water resistance properties compared to areas without a thermoformed melted yarn component 212. Further, because these properties are provided through the knit structure instead of being applied as an additional layer or film, the portion 200 of the knitted component may remain relatively thin and flexible. As such, the melted yarn component 212 may be utilized in high-flex areas of an upper, such as the area between the throat and the forefoot region, without premature wear or breakage.

Note that FIGS. 2A and 2B are merely examples of knitting and thermoforming, as described herein. Other knit patterns with any plurality of adjacent rows, and/or any plurality of adjacent loops, of predominately the first yarn 210 or of predominately the second yarn 208 may be used for forming the knitted component 128 as described herein without departing from the scope of the technology herein. For example, for simplicity of the illustration, the portion 200 is shown with only a single knit layer. However, it is contemplated that aspects of the disclosure may include a knitted component with a double-knit structure formed using needles on two needle beds. For example, the first yarn 210 may be knit on a front needle bed to form the loops in the third course 206 in FIG. 2A, which may form the first surface of the knitted component, and in another course, such as a course knit simultaneously with the first course 202, the first yarn 210 may be knit on the back needle bed to form at least part of the second surface of the knitted component. Similarly, the second yarn 208 may be knit on a front needle bed to form the loops in the first course 202 and the second course 204 in FIG. 2A, which may form the first surface of the knitted component, and in another course, such as a course knit simultaneously with the third course 206, the second yarn 208 may be knit on the back needle bed to form at least part of the second surface of the knitted component. In some aspects, the first yarn 210 and/or the second yarn 208 may be moved back and forth between front and back needle beds within a single course. Additionally, in some aspects in which the portion 200 is part of a double-knit structure, loops forming courses for the first surface and/or second surface may be formed from a third or additional yarn. Further, in some aspects having a double-knit structure, the melted yarn component 212 may extend between the knit layers but not fully extend through the back layer to form the second surface. In alternative configurations, the melted yarn component 212 may still extend completely through both knit layers of a double-knit structure.

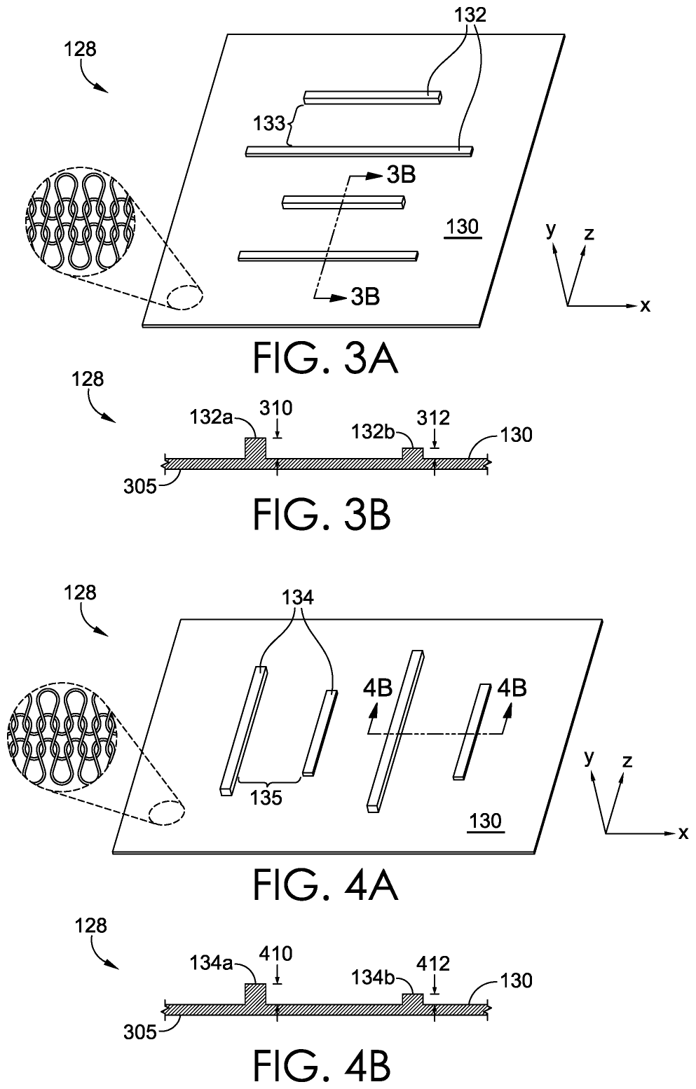

FIG. 3A depicts a perspective view of a portion of the knitted component 128 that forms the first surface 130 of the knitted component 128 of the upper 124 of FIG. 1A and further depicts a portion of the first set of raised elements 132 that is located on the lateral side of the article of footwear 100 of FIG. 1A. The first set of raised elements 132 extends in a generally horizontal direction (e.g., from a toe area toward a heel area). The first surface 130 of the knitted component 128 extends along an x/y-plane, and the first set of raised elements 132 extends in a positive z-direction with respect to the first surface 130. Each raised element 132 is separated from an adjacent raised element by intervening segments 133 which may, in some example aspects, also comprise a thermoformed network of interlooped yarns.

FIG. 3B illustrates a cross-section taken at cut line 3B-3B of FIG. 3A. The knitted component 128 includes the first surface 130 and further includes an opposite second surface 305, which may form an interior surface of the upper 124. The first set of raised elements 132 includes at least a first raised element 132a having a first height 310 in the z-direction and a second raised element 132b having a second height 312 in the z-direction where the second height 312 is less than the first height 310. The height of the individual raised elements, such as the first raised element 132a and the second raised element 132b, may be adjusted to achieve a desired level of stiffness and/or rigidity of the knitted component 128. For example, a greater height in the z-direction (e.g., the first raised element 132a) may help to lock in place a greater surface area of interlooped yarns to impart an increased stiffness compared to having a lesser height in the z-direction (e.g., the second raised element 132b). The difference in heights shown is illustrative, and aspects herein contemplate that each of the first set of raised elements 132 may have the same height, such as the first height 310 or the second height 312.

FIG. 4A depicts a perspective view of a portion of the knitted component 128 that forms the first surface 130 of the upper 124 of FIG. 1A and further depicts a portion of the second set of raised elements 134 (or 152) that are located on the medial side of the article of footwear 100 of FIG. 1A. Although FIG. 4A identifies the second set of raised elements as the second set of raised elements 134 depicted in FIGS. 1B-1C, it is understood that the description of the second set of raised elements 134 with respect to FIGS. 4A and 4B may equally apply to the second set of raised elements 152 depicted in FIG. 1D. The second set of raised elements 134 (or 152) extends in a generally vertical direction (e.g., from a lower area toward a throat area). The first surface 130 of the knitted component 128 extends along an x/y-plane, and the second set of raised elements 134 (or 152) extends in a positive z-direction with respect to the first surface 130. Each raised element 134 (or 152) is separated from an adjacent raised element by intervening segments 135, which may also, in some example aspects, comprise a thermoformed network of interlooped yarns.

FIG. 4B illustrates a cross-section taken at cut line 4B-4B of FIG. 4A. The knitted component 128 includes the first surface 130 and further includes the opposite second surface 305. The second set of raised elements 134 (or 152) includes at least a first raised element 134a having a first height 410 in the z-direction and a second raised element 134b having a second height 412 in the z-direction where the second height 412 is less than the first height 410. Similar to the first set of raised elements 132, the height of the individual raised elements, such as the first raised element 134a and the second raised element 134b, may be adjusted to achieve a desired level of stiffness and/or rigidity of the knitted component 128. The difference in heights shown is illustrative, and aspects herein contemplate that each of the second set of raised elements 134 (or 152) may have the same height such as the first height 410 or the second height 412. The description of FIG. 4B is also applicable to the second set of raised elements 152.

The depiction of the cross-sectional shape of the first set of raised elements 132 and the second set of raised elements 134 (or 152) in FIGS. 3B and 4B is illustrative. For example, the depicted rectangular cross-sectional shape of the raised elements 132 and 134 may be based upon the molding process used to form the raised elements. With respect to the example first molding process described above that utilizes a first mold plate having depressions, the shape of the depressions in the first mold plate may be rectangular, which imparts the rectangular shape to the first set of raised elements 132 and the second set of raised elements 134 (or 152). Aspects herein contemplate depressions that impart a triangular cross-sectional shape, a rounded cross-sectional shape, or other cross-sectional shapes to the first set of raised elements 132 and the second set of raised elements 134 (or 152). The example second molding process described above may impart a more rounded cross-sectional shape, such as a hemispherical cross-sectional shape, to the first set of raised elements 132 and the second set of raised elements 134 (or 152) due to the more pliable nature of the flexible pad.

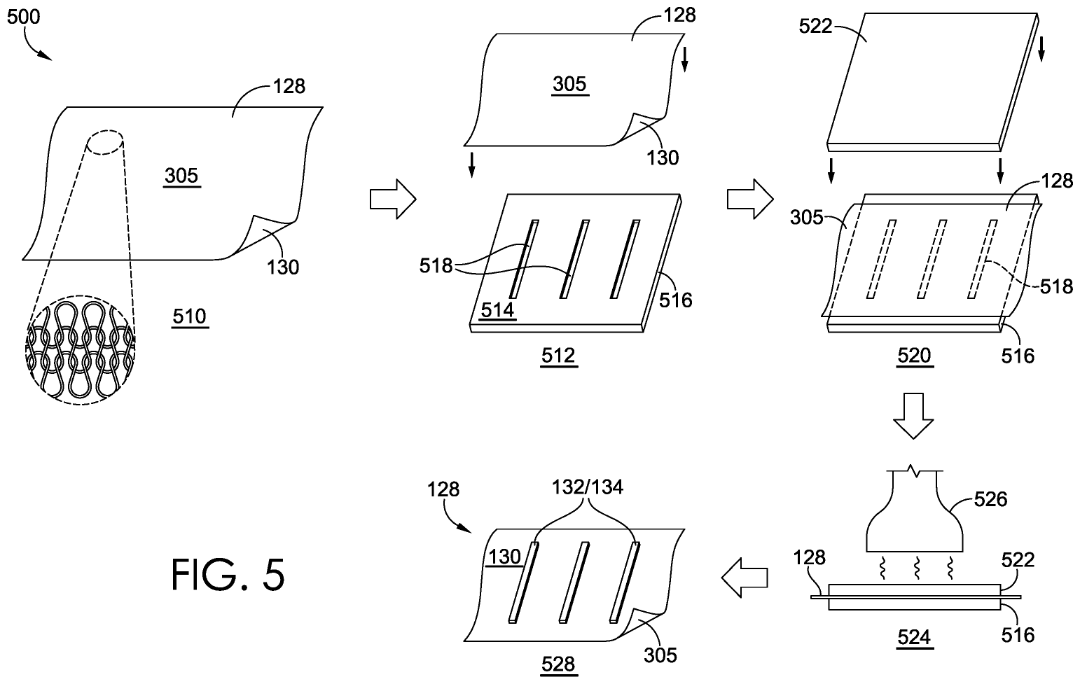

FIG. 5 illustrates a schematic of a first example manufacturing process 500 for thermoforming raised elements such as one or more of the first set of raised elements 132 and the second set of raised elements 134 (or 152). Reference numerals associated with the knitted component 128 will be used with respect to the process 500, but aspects herein contemplate that the process 500 may be used with any knitted or woven component formed using at least the first yarn described herein, where the knitted or woven component may be used to form an article.

At a step 510, the knitted component 128 having the first surface 130 and the opposite second surface 305 are provided. The knitted component 128 includes at least a first yarn, such as the first yarn 210, having a first coating surrounding a core yarn. In some aspects, step 510 includes forming the knitted component 128 on a knitting machine. At a step 512, the first surface 130 of the knitted component 128 is placed adjacent to a molding surface 514 of a first mold plate 516. In aspects herein, the first mold plate 516 has a rigid structure and further may be a metal mold plate. In one example, the first mold plate 516 is an aluminum mold plate. It is contemplated that other rigid materials may be used for the first mold plate 516, such as stainless steel, titanium, magnesium alloy, and fiberglass. The first mold plate 516 includes depressions 518 extending down and away from the molding surface 514 and extending away from the knitted component 128 when the knitted component 128 is placed adjacent the molding surface 514. The depressions 518 are arranged in a pattern corresponding to a desired pattern for the first set of raised elements 132 and/or the second set of raised elements 134 (or 152). The depressions 518 may include depressions having varying depths. Alternatively, each of the depressions 518 may have the same depth.

At a step 520, a second mold plate 522 is placed adjacent to the second surface 305 of the knitted component 128. The second mold plate 522 may have a rigid structure and may be a metal mold plate. In some aspects, the second mold plate 522 is formed from the same material as the first mold place 516. For example, the second mold plate 522 may be formed from aluminum. In example aspects, the surface of the second mold plate 522 that is placed adjacent to the second surface 305 of the knitted component 128 may comprise a smooth, planar surface. In an alternate aspect, the surface of the second mold plate 522 that is adjacent to the knitted component 128 during thermoforming may include projections that mate with the depressions 518 on the first mold plate 516.

At a step 524, one or more of heat and pressure 526 is applied to one or more of the first mold plate 516 and/or the second mold plate 522 at a sufficient temperature and for a sufficient period of time to cause the first coating on the first yarn to reflow. The reflowing of the first coating at least partially fills the depressions 518 of the first mold plate 516 with a thermoformed network of interlooped yarns to form one or more of the first set of raised elements 132 and/or the second set of raised elements 134 (or 152).

In some aspects, the temperature that the knitted component 128 reaches for thermoforming at step 524 is within a range of about 125 degrees Celsius and 175 degrees Celsius. In one example, the knitted component 128 is heated at step 524 until it reaches about from about 125 degrees Celsius to about 175 degrees Celsius, from about 145 degrees Celsius to about 170 degrees Celsius, from about 150 degrees Celsius to about 165 degrees Celsius, or from about 155 degrees Celsius to about 160 degrees Celsius. In example aspects, the thermoforming temperature of the knitted component 128 may be dependent upon a type of polymer used to coat the first yarn. Further, in some aspects, the pressure applied to one or more of the first mold plate 516 and the second mold plate 518 is within a range of about 25 bar to about 35 bar. In one example, a total of 30 bar is applied to the combination of the first mold plate 516 and the second mold plate 518.

Step 528 illustrates the knitted component 128 after the first coating has resolidified in a pattern corresponding to the first set of raised elements 132 and/or the second set of raised elements 134 (or 152). Due to the positioning of the first surface 130 of the knitted component 128 adjacent to the surface 514 of the first mold plate 516 having the depressions 518, the raised elements 132 and 134 are positioned such that they extend in the z-direction away from the first surface 130 of the knitted component 128. The knitted component 128 may be further formed into, for example, the upper 124 such that the first surface 130 forms an outer surface of the upper 124.

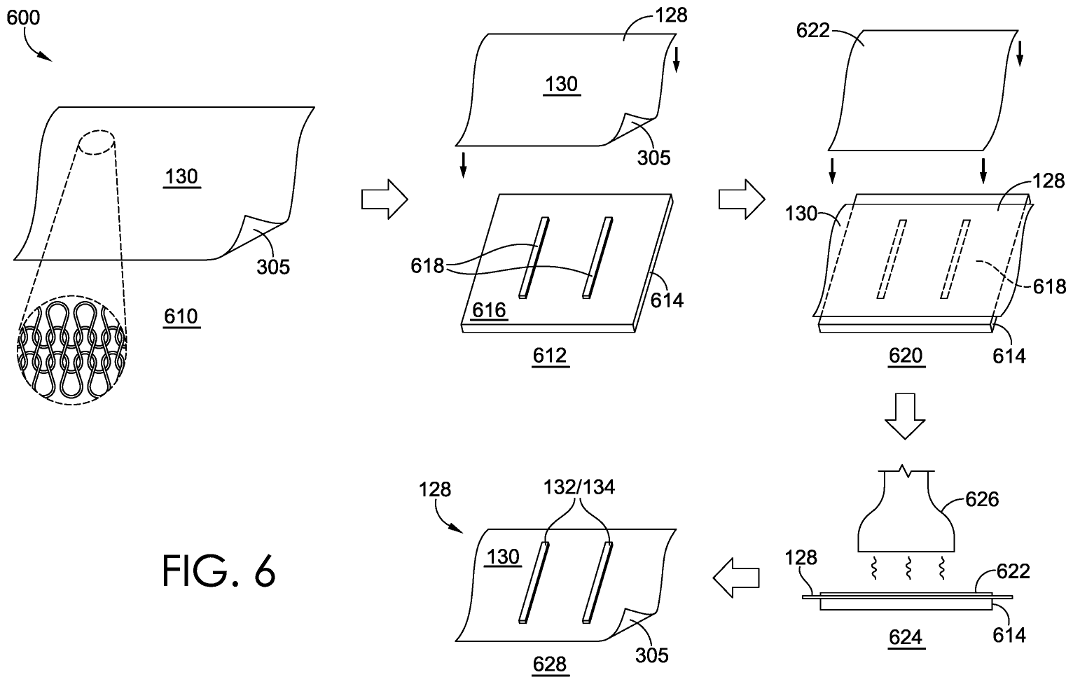

FIG. 6 illustrates a schematic of a second example manufacturing process 600 for thermoforming raised elements such as one or more of the first set of raised elements 132 and the second set of raised elements 134 (or 152). Reference numerals associated with the knitted component 128 will be used with respect to the process 600, but aspects herein contemplate that the process 600 may be used with any knitted or woven component formed using at least the first yarn described herein, where the knitted or woven component may be used to form an article.

At a step 610, the knitted component 128 having the first surface 130 and the opposite second surface 305 is provided. The knitted component 128 includes at least a first yarn, such as the first yarn 210, having a first coating surrounding a core yarn. At a step 612, the second surface 305 of the knitted component 128 is placed adjacent to a surface 616 of a mold plate 614, which may have a rigid structure and further may be a metal mold plate. In one example, the mold plate 614 is an aluminum mold plate. The mold plate 614 includes projections 618 that extend upward from the surface 616 of the mold plate 614 such that the projections 618 extend towards the knitted component 128 when the knitted component 128 is placed on the surface 616 of the mold plate 614. The projections 618 on the mold plate 614 are arranged in a pattern corresponding to a desired pattern for the first set of raised elements 132 and/or the second set of raised elements 134 (or 152). The projections 618 may include projections having varying heights. Alternatively, each of the projections 618 may have the same height.

At a step 620, a heat-resistant, pliable, and deformable pad 622 is placed adjacent the first surface 130 of the knitted component 128. In example aspects, the pliable pad 622 may comprise a silicone pad. In example aspects, the pliable pad may be planar without preformed depressions or projections. At a step 624, heat and/or pressure 626 is applied to one or more of the pliable pad 622 and/or the mold plate 614 at a sufficient temperature and for a sufficient period of time to cause the first coating on the first yarn to reflow. The projections 618 of the mold plate 614 push the thermoformed network of interlooped yarns into the pliable and deformable pad 622 to form one or more of the first set of raised elements 132 and/or the second set of raised elements 134 (or 152).

In some aspects, the temperature that the knitted component 128 reaches for thermoforming at step 624 is within a range of about 125 degrees Celsius and 175 degrees Celsius. In one example, the knitted component 128 is heated at step 624 until it reaches about 140 degrees Celsius or about 165 degrees Celsius. Further, in some aspects, the pressure applied to one or more of the mold plate 614 and the pliable pad 622 is within a range of about 15 bar to about 30 bar. In one example, the amount of pressure applied in total to the mold plate 614 and the pliable pad 622 is less than 30 bar.

Some aspects further include a cold press, where pressure is applied without heat following at least one cycle of heat with pressure. In some examples, the temperature for the cold press is within a range from about 0 degrees Celsius and 10 degrees Celsius. The pressure applied to one or more of the mold plate 614 and the pliable pad 622 during the cold press may be within a range of about 15 bar to about 30 bar. The pliable pad 622 used during the cold press may be different from the pliable pad 622 used during a cycle with heat or at least may be cooled before use with the cold press.

Step 628 illustrates the knitted component 128 after the first coating has resolidified in a pattern corresponding to the first set of raised elements 132 and/or the second set of raised elements 134 (or 152). Due to the positioning of the first surface 130 of the knitted component 128 away from the mold plate 614 having the projections 618, the raised elements 132 and/or 134 are positioned such that they extend in the z-direction away from the first surface 130 of the knitted component 128. The knitted component 128 may be further formed into, for example, the upper 124 such that the first surface 130 forms an outer surface of the upper 124.

Because the pad 622 is pliable and/or deformable, the raised elements 132, 134, and/or 152 may have a less defined shape compared to the raised elements formed using the process 500. For example, the raised elements 132, 134, or 152 formed using the process 600 may be more rounded. Further, because it may be more difficult to obtain a tight seal between the pliable pad 622 and the mold plate 614 compared to the first and second mold plates 516 and 522 of the process 500, heat may escape or dissipate more quickly using the process 600. In example aspects, this may cause the raised elements 132, 134, or 152 to retain more of a knit structure compared to the raised elements formed using the process 500. Stated differently, the amount of thermoforming using the process 600 may be less than is used during the process 500. The enhanced knit structure of the raised elements created using the process 600 may contribute to increased grip or traction of the raised elements. This may be desirable in some instances.

### Example Properties of the First Yarn

As discussed above, textiles and shaped components may include the selective incorporation of yarns (referred to above as a first yarn) as described alone or in combination with other materials (e.g., second yarns that do not fall under the fibers, filaments, and yarns described herein). In certain aspects, the yarns and/or fibers described herein may be used to provide a specific functionality. For example, in certain aspects, yarn as described herein may be thermoformed to form a film having waterproof or water-resistant properties.

In one aspect, coated yarns, such as the first yarn, described herein have a break strength of about 0.6 to about 0.9 kilograms of applied force, or of about 0.7 to about 0.9 kilograms of applied force, or of about 0.8 to about 0.9 kilograms of applied force, or greater than 0.9 kilograms of applied force.

In an aspect, the yarns described herein are produced from fibers or filaments composed of only a single thermoplastic elastomer. In other aspects, the fibers are composed of a blend of two or more different thermoplastic elastomers.

In one aspect, the yarn is a coated yarn, wherein a core yarn comprises a second polymeric composition and a coating layer disposed on the core yarn, the coating layer comprising the first polymeric composition, wherein the first polymeric composition has a first melting temperature. In one aspect, the second polymeric composition is a second thermoplastic composition having a second deformation temperature, and the second deformation temperature is at least 20 degrees Celsius greater, at least 50 degrees Celsius greater, at least 75 degrees Celsius greater, or at least 100 degrees Celsius greater than the first melting temperature of the first polymeric composition. In another aspect, the second polymeric composition is a second thermoplastic composition having a second melting or deformation temperature, and the second deformation temperature is about 20 degrees Celsius greater, about 50 degrees Celsius greater, about 75 degrees Celsius greater, or about 100 degrees Celsius greater than the first melting temperature of the first polymeric composition.

In one aspect, the first polymeric composition includes a polymeric component. In one aspect, the first polymeric composition may include a single polymeric component (e.g., a single thermoplastic elastomer). In other aspects, the first polymeric composition may include two or more polymeric components (e.g., two or more different thermoplastic elastomers).

In one aspect, the second polymeric composition is a first thermoset composition. In one aspect, the second polymeric composition comprises a second thermoset composition. The core yarn may be any material that retains its strength at the temperature at which the first polymeric material is extruded during the coating process. The core yarn may be natural fibers, regenerated fibers or filaments, or synthetic fibers or filaments. In one aspect, the core yarn may be composed of cotton, silk, wool, rayon, nylon, elastane, polyester, polyamide, polyurethane, or polyolefin. In one aspect, the core yarn is composed of polyethylene terephthalate (PET). In one aspect, the second polymeric composition has a deformation temperature greater than 200 degrees Celsius, greater than 220 degrees Celsius, greater than 240 degrees Celsius, or between about 200 degrees Celsius to about 300 degrees Celsius.

In one aspect, the core yarn is a staple yarn, a multi-filament yarn, or a mono-filament yarn. In one aspect, the core yarn is polytwisted. In one aspect, the core yarn has a linear density of about 100 denier to about 300 denier, or of about 100 to about 250 denier, or about 100 to about 200 denier, or about 100 to 150 denier, or about 150 to 300 denier, or about 200 to 300 denier, or about 250 to 300 denier. In one aspect, the core yarn has a thickness of about 60 microns to 200 microns, about 60 to 160 microns, about 60 to 120 microns, about 60 to 100 microns, about 100 to 200 microns, or about 140 to 200 microns.

In one aspect, the core yarn is polyethylene terephthalate having a thickness of about 100 denier to about 200 denier, about 125 denier to about 175 denier, or about 150 denier to 160 denier. In one aspect, the core yarn is polyethylene terephthalate having a percent elongation of about 20 percent to about 30 percent, about 22 percent to about 30 percent, about 24 percent to about 30 percent, about 20 percent to about 28 percent, or about 20 percent to about 26 percent. In one aspect, the core yarn is polyethylene terephthalate having a tenacity of about one gram per denier to about ten grams per denier, about three grams per denier to about ten grams per denier, about five grams per denier to about ten grams per denier, about one gram per denier to about seven grams per denier, or about one gram per denier to about five grams per denier.

In one aspect, the coated yarn may be produced by extruding the coating (i.e., the first polymeric composition) onto the core yarn through an annular die or orifice such that the coating layer is axially centered surrounding the core yarn. The thickness of the coating applied to the core yarn may vary depending upon the application of the yarn. In one aspect, the coated yarn is used to produce a knitted textile. In one aspect, the coated yarn has a nominal average outer diameter of up to 1.00 millimeter, or of up to about 0.75 millimeters, or of up to about 0.5 millimeters, or of up to about 0.25 millimeters, or of up to about 0.2 millimeters, or of up to about 0.1 millimeters. In another aspect, the coating has a nominal average outer diameter of about 0.1 millimeters to about 1.00 millimeter, or about 0.1 millimeters to about 0.80 millimeters, or about 0.1 millimeters to about 0.60 millimeters. In another aspect, the coating on the yarn has an average radial coating thickness of about 50 micrometers to about 200 micrometers, or about 50 micrometers to about 150 micrometers, or about 50 micrometers to about 125 micrometers.

In one aspect, the core yarn has a thickness of about 100 denier to about 200 denier, about 125 denier to about 175 denier, or about 150 denier to 160 denier, and the coating has a nominal average outer diameter of about 0.10 millimeters to about 0.50 millimeters, or of about 0.10 millimeters to about 0.25 millimeters, or of about 0.10 millimeters to about 0.20 millimeters. In one aspect, the core yarn is polyethylene terephthalate having a thickness of about 100 denier to about 200 denier, about 125 denier to about 175 denier, or about 150 denier to about 160 denier, and the coating has a nominal average outer diameter of about 0.10 millimeters to about 0.50 millimeters, or of about 0.10 millimeters to about 0.25 millimeters, or of about 0.10 millimeters to about 0.20 millimeters.

In a further aspect, the coated yarn has a net total diameter from about 0.2 to about 0.6 millimeters, or about 0.3 to about 0.5 millimeters, or about 0.4 to about 0.6 millimeters. In some aspects, a lubricating oil including but not limited to, mineral oil or silicone oil, is present on the yarn at from about 0.5 percent to about two percent by weight, or from about 0.5 percent to about 1.5 percent by weight, or from about 0.5 percent to about one percent by weight. In some aspects, lubricating compositions are applied to the surface of the coated yarn before or during the process of forming the textile. In some aspects, the thermoplastic composition and the lubricating composition are miscible when the thermoplastic composition is reflowed and resolidified in the presence of the lubricating composition. Following reflowing and resolidification, the reflowed and solidified composition may comprise the lubricating composition.

In one aspect, the core yarn has a percent elongation of about eight percent to about 30 percent, about ten percent to about 30 percent, about 15 percent to about 30 percent, about 20 percent to about 30 percent, about ten percent to about 25 percent, or about ten percent to about 20 percent. In one aspect, the core yarn has a tenacity of about one gram per denier to about ten grams per denier, about two grams per denier to about eight grams per denier, about four grams per denier to about eight grams per denier, or about two grams per denier to about six grams per denier.

In one aspect, when thermoformed, the polymeric composition of the first coating has a melting temperature from about 100 degrees Celsius to about 210 degrees Celsius, optionally from about 110 degrees Celsius to about 195 degrees Celsius, from about 120 degrees Celsius to about 180 degrees Celsius, or from about 120 degrees Celsius to about 170 degrees Celsius. In another aspect, the first polymeric composition has a melting temperature greater than about 120 degrees Celsius and less than about 170 degrees Celsius, and optionally greater than about 130 degrees Celsius and less than about 160 degrees Celsius.

In a further aspect, when the melting temperature is greater than 100 degrees Celsius, the integrity of articles formed from or incorporating the first polymeric composition is preserved if the articles briefly encounter similar temperatures, for example, during shipping or storage. In another aspect, when the melting temperature is greater than 100 degrees Celsius, or greater than 120 degrees Celsius, articles formed from or incorporating the first polymeric composition may be steamed without melting or uncontrollably fusing any polyester components incorporated in the articles for purposes such as fill, zonal surface, or comfort features, as well as stretch yarn used for snugness and fit features.

In one aspect, when the melting temperature is greater than 120 degrees Celsius, materials incorporating the first or second polymeric composition disclosed herein are unlikely to soften and/or become tacky during use on a hot paved surface, a court surface, an artificial or natural football pitch, or a similar playing surface, track, or field. In one aspect, the higher the melting temperature of the first or second polymeric composition and the greater its enthalpy of melting, the greater the ability of an article of footwear or athletic equipment incorporating or constructed from the first or second polymeric composition to withstand contact heating excursions, frictional surface heating events, or environmental heating excursions. In one aspect, such heat excursions may arise when the articles contact hot ground, court, or turf surfaces, or heat excursions may arise from frictional heating that comes from rubbing or abrasion when the articles contact another surface such as the ground, another shoe, a ball, or the like.

In another aspect, when the melting temperature is less than about 210 degrees Celsius, or less than about 200 degrees Celsius, or less than about 190 degrees Celsius, or less than about 180 degrees Celsius, or less than about 175 degrees Celsius, but greater than about 120 degrees Celsius, or greater than about 110 degrees Celsius, or greater than about 103 degrees Celsius, polymer coated yarns may be melted for the purposes of molding and/or thermoforming a given region of textiles knitted therefrom in order to impart desirable design and aesthetic features in a short period of time.

In one aspect, a melting temperature lower than 140 degrees Celsius prevents or mitigates the risk of dye migration from polyester yarns incorporated in the footwear or other articles. In a further aspect, dye migration from package-dyed polyester yarns or filaments is a diffusion-limited process, and short periods of exposure to temperatures greater than 140 degrees Celsius, such as during thermoforming, do not extensively damage, discolor, or otherwise render the appearance of the footwear or other articles unacceptable. However, in another aspect, if the melting temperature of the polymer coating is greater than about 210 degrees Celsius, thermal damage and dye migration may occur.

In one aspect, a high melting enthalpy indicates that a longer heating time is required to ensure a polymer is fully melted and will flow well. In another aspect, a low melting enthalpy requires less heating time to ensure full melting and good flow.

In a further aspect, high cooling exotherms indicate rapid transitions from molten to solid. In another aspect, higher recrystallization temperatures indicate polymers are capable of solidifying at higher temperatures. In one aspect, high-temperature solidification is beneficial for thermoforming. In one aspect, recrystallization above 95 degrees Celsius promotes rapid setting after thermoforming, reduces cycle time, reduces cooling demands, and improves stability of shoe components during assembly and use.

In one aspect, viscosity of the coating compositions disclosed herein affects the properties and processing of the coating compositions. In a further aspect, high viscosities at low shear rates (e.g., less than one reciprocal second) indicate resistance to flow, displacement, and more solid-like behavior. In another aspect, low viscosities at higher shear rates (e.g., greater than ten reciprocal seconds) lend themselves to high-speed extrusion. In one aspect, as viscosity increases, the ability to adequately flow and deform to coat core yarn substrate becomes challenging. In another aspect, materials that exhibit high shear thinning indices (e.g., where viscosity at ten or 100 reciprocal seconds is lower than at one reciprocal second) may be challenging to extrude and may melt fracture if coated or extruded at a velocity that is too high.

In one aspect, the composition forming the first areas has a durometer Shore A hardness of about 50 to about 90 Shore A, optionally from about 55 to about 85 Shore A, from about 60 to about 80 Shore A, from about 60 to about 70 Shore A, or from about 67 to about 77 shore A.

In various aspects, the first polymeric composition for coating yarn has a cold Ross flex test result of about 120,000 to about 180,000 cycles, or of about 140,000 to about 160,000 cycles, or of about 130,000 to about 170,000 cycles when tested on a thermoformed plaque of the first polymeric composition for coating yarn in accordance with the cold Ross flex test as described herein below.

In one aspect, the polymeric composition or coating of the first yarn or the first areas has two or more of the first properties, or optionally three or more, four or more, five or more, six or more, seven or more, or all ten first properties provided above.

In addition to the first properties, when thermoformed, the first coating or polymeric composition of the first yarn or the first areas has one or more second properties. In one aspect, when thermoformed, the first coating or polymeric composition of the first yarn or the first areas has a glass transition temperature less than 50 degrees Celsius, optionally less than 30 degrees Celsius, less than zero degrees Celsius, less than −10 degrees Celsius, less than −20 degrees Celsius, or less than −30 degrees Celsius. In one aspect, when thermoformed, the first coating or polymeric composition of the first yarn or the first areas has a stress at break greater than seven megapascals, optionally greater than eight megapascals, as determined using the Modulus, Tenacity, and Elongation Test, at 25 degrees Celsius. In one aspect, when thermoformed, the first coating or polymeric composition of the first yarn or the first areas has a tensile stress at 300 percent modulus greater than two megapascals, optionally greater than 2.5 megapascals, or greater than three megapascals, as determined using the Modulus, Tenacity, and Elongation Test, at 25 degrees Celsius. In one aspect, when thermoformed, the first coating or polymeric composition of the first yarn or first areas has an elongation at break greater than 400 percent, optionally greater than 450 percent, optionally greater than 500 percent, or greater than 550 percent, as determined using the Modulus, Tenacity, and Elongation Test, at 25 degrees Celsius. In another aspect, when thermoformed, the first coating or polymeric composition of the first yarn or the first areas has two or more of the second properties, or optionally three or more, or all four second properties.

In certain aspects, the films, fibers, and yarns described herein can exhibit a tenacity greater than one gram/denier. In one aspect, the films, fibers, and yarns described herein can exhibit a tenacity of from about one gram/denier to about five grams/denier. In one or more aspects, the films, fibers, and yarns described herein can exhibit a tenacity of from about 1.5 grams/denier to about 4.5 grams/denier. In one aspect, the films, fibers, and yarns described herein can exhibit a tenacity of from about two grams/denier to about 4.5 grams/denier. “Tenacity” as used herein refers to a property of a fiber or yarn, and is determined using the respective testing method and sampling procedure described as follows. Specifically, tenacity and elongation of the yarn sample are determined according to the test method detailed in EN-ISO 2062 with the pre-load set to five grams. Elongation is recorded at the maximum tensile force value applied prior to breaking. Tenacity can be calculated as the ratio of load required to break the specimen to the linear density of the specimen.

In certain aspects, it may be desired to utilize a yarn that is suitable for use on commercial knitting equipment. A free-standing shrinkage of a yarn at 50 degrees Celsius is one property that can be predictive of a suitable yarn for use on a commercial knitting machine. In certain aspects, the films, fibers, filaments, and yarns described herein can exhibit a free-standing shrinkage when heated from 20 degrees Celsius to 70 degrees Celsius of less than 15 percent. In various aspects, the films, fibers, and yarns described herein can exhibit free-standing shrinkage when heated from 20 degrees Celsius to 70 degrees Celsius of about 0 percent to about 60 percent, about 0 percent to about 30 percent, or about 0 percent to about 15 percent. The term “free-standing shrinkage” as used herein refers to a property of a yarn and a respective testing method described as follows:

Yarn Shrinkage Test. The free-standing shrinkage of yarns can be determined by the following method. A yarn sample is prepared according to the Yarn Sampling Procedure described below, and is cut to a length of approximately 30 millimeters with minimal tension at approximately room temperature (e.g., 20 degrees Celsius). The cut sample is placed in a 50 degrees Celsius or 70 degrees Celsius oven for 90 seconds. The sample is removed from the oven and measured. The percentage of shrink is calculated using the pre-oven and post-oven measurements of the sample by dividing the post-oven measurement by the pre-oven measurement and multiplying by 100.

Yarn Sampling Procedure. Yarn to be tested is stored at room temperature (20 degrees Celsius to 24 degrees Celsius) for 24 hours prior to testing. The first three meters of material are discarded. A sample yarn is cut to a length of approximately 30 millimeters with minimal tension at approximately room temperature (e.g., 20 degrees Celsius).

In one or more aspects, the free-standing shrinkage of a yarn at 70 degrees Celsius can be a useful indicator of the ability of a yarn to be exposed to certain environmental conditions without any substantial changes to the physical structure of the yarn. In certain aspects, a yarn comprising the low-processing temperature polymeric composition can exhibit a free-standing shrinkage when heated from 20 degrees Celsius to 70 degrees Celsius of from about 0 percent to about 60 percent. In one or more aspects, a yarn comprising the low-processing temperature polymeric composition can exhibit a free-standing shrinkage when heated from 20 degrees Celsius to 70 degrees Celsius of from about 0 percent to about 30 percent. In one aspect, a yarn comprising the low-processing temperature polymeric composition can exhibit a free-standing shrinkage when heated from 20 degrees Celsius to 70 degrees Celsius of from about 0 percent to about 20 percent.

As discussed above, in certain aspects, the first polymeric composition as described herein and the second polymeric composition have differing properties. In various aspects, these differing properties allow for the coated fibers, as described herein, during a thermoforming process, to melt and flow, and subsequently cool and solidify into a different structure than of that prior to the thermoforming process (e.g., thermoform from a yarn to a melted yarn component), while an uncoated fiber cannot deform or melt during such a process and can maintain its structure (e.g., as a yarn) when the thermoforming process is conducted at a temperature below the melting temperature of the uncoated fibers. In such aspects, the melted yarn component formed from the coated fibers as described herein during the thermoforming process may be integrally connected to the non-altered structure (e.g., a yarn or fiber), which can provide three-dimensional structure and/or other properties targeted to specific spots on an article of wear.

### Example Thermoplastic Elastomers

In various aspects, the polymeric compositions for the coating of the first yarn described herein comprise one or more thermoplastic elastomers. In an aspect, an “elastomer” is defined as a material having an elongation at break greater than 400 percent as determined using ASTM D-412-98 at 25 degrees Celsius. In another aspect, the elastomer is formed into a plaque, wherein the plaque has a break strength of from ten to 35 kilogram-force (kgf), or of from about ten to about 25 kilogram-force, or of from about ten to about 20 kilogram-force, or of from about 15 to about 35 kilogram-force, or of from about 20 to about 30 kilogram-force. In another aspect, tensile breaking strength or ultimate strength, if adjusted for cross-sectional area, is greater than 70 kilogram-force per square centimeter, or greater than 80 kilogram-force per square centimeter. In another aspect, the elastomer plaque has a strain to break of from 450 percent to 800 percent, or from 500 to 800 percent, or from 500 to 750 percent, or from 600 to 750 percent, or from 450 to 700 percent. In still another aspect, the elastomer plaque has a load at 100 percent strain of from about three to about eight kilogram-force per millimeter, or of from about three to about seven kilogram-force per millimeter, or of from about 3.5 to about 6.5 kilogram-force per millimeter, or of from about four to about five kilogram-force per millimeter. In one aspect, the elastomer plaque has a toughness of from 850 kilogram·millimeters to 2,200 kilogram·millimeters, or of from about 850 kilogram·millimeters to about 2,000 kilogram·millimeters, or of from about 900 kilogram·millimeters to about 1,750 kilogram·millimeters, or of from about 1,000 kilogram·millimeters to about 1,500 kilogram·millimeters, or of from about 1,500 kilogram·millimeters to about 2,000 kilogram·millimeters. In an aspect, the elastomer plaque has a stiffness of from about 35 to about 155, or of from about 50 to about 150, or of from about 50 to about 100, or of from about 50 to about 75, or of from about 60 to about 155, or of from about 80 to about 150. In still another aspect, the elastomer plaque has a tear strength of from about 35 to about 80, or of from about 35 to about 75, or of from about 40 to about 60, or of from about 45 to about 50.

In aspects, exemplary thermoplastic elastomers include homopolymers and copolymers. The term “polymer” refers to a polymerized molecule having one or more monomer species, and includes homopolymers and copolymers. The term “copolymer” refers to a polymer having two or more monomer species, and includes terpolymers (i.e., copolymers having three monomer species). In certain aspects, the thermoplastic elastomer is a random copolymer. In one aspect, the thermoplastic elastomer is a block copolymer. For example, the thermoplastic elastomer may be a block copolymer having repeating blocks of polymeric units of the same chemical structure (segments) that are relatively harder (hard segments), and repeating blocks of polymeric segments that are relatively softer (soft segments). In various aspects, in block copolymers, including block copolymers having repeating hard segments and soft segments, physical cross-links may be present within the blocks or between the blocks or both within and between the blocks. Particular examples of hard segments include isocyanate segments and polyamide segments. Particular examples of soft segments include polyether segments and polyester segments. As used herein, the polymeric segment may be a particular type of polymeric segment such as, for example, an isocyanate segment, a polyamide segment, a polyether segment, a polyester segment, and the like. It is understood that the chemical structure of the segment is derived from the described chemical structure. For example, an isocyanate segment is a polymerized unit including an isocyanate functional group. When referring to a block of polymeric segments of a particular chemical structure, the block may contain up to ten mol percent of segments of other chemical structures. For example, as used herein, a polyether segment is understood to include up to ten mol percent of non-polyether segments.

In one aspect, the first polymeric composition comprises a polymeric component consisting of all the polymers present in the polymeric composition; optionally, wherein the polymeric component comprises two or more polymers, wherein the two or more polymers differ from each other in chemical structure of individual segments of each of the two or more polymers, or in molecular weight of each of the two or more polymers, or in both.

In various aspects, the thermoplastic elastomer may include one or more of a thermoplastic copolyester elastomer, a thermoplastic polyether block amide elastomer, a thermoplastic polyurethane elastomer, a polyolefin-based copolymer elastomer, a thermoplastic styrenic copolymer elastomer, a thermoplastic ionomer elastomer, or any combination thereof. In one aspect, the first polymeric composition comprises a thermoplastic elastomeric styrenic copolymer. In a further aspect, the thermoplastic elastomeric styrenic copolymer may be a styrene butadiene styrene (SBS) block copolymer, a styrene ethylene/butylene styrene (SEBS) resin, a styrene acrylonitrile (SAN) resin, or any combination thereof. In one aspect, a polymeric composition comprises a thermoplastic elastomeric polyester polyurethane, a thermoplastic polyether polyurethane, or any combination thereof. In some aspects, the thermoplastic elastomeric polyester polyurethane may be an aromatic polyester, an aliphatic composition, or a combination thereof. It should be understood that other thermoplastic polymeric materials not specifically described below are also contemplated for use in the coated fiber, as described herein, and/or in an uncoated fiber. In one aspect, a polymeric composition comprising a thermoplastic elastomer has a melting temperature greater than about 110 degrees Celsius and less than about 170 degrees Celsius. In another aspect, a polymeric composition comprising a thermoplastic elastomer has a melting temperature of about 110 degrees Celsius to about 170 degrees Celsius, about 115 degrees Celsius to about 160 degrees Celsius, about 120 degrees Celsius to about 150 degrees Celsius, about 125 degrees Celsius to about 140 degrees Celsius, about 110 degrees Celsius to about 150 degrees Celsius, or about 110 degrees Celsius to about 125 degrees Celsius.

In various aspects, the thermoplastic elastomer has a glass transition temperature (Tg) less than 50 degrees Celsius when determined in accordance with ASTM D3418-97 as described herein below. In some aspects, the thermoplastic elastomer has a glass transition temperature (Tg) of about −60 degrees Celsius to about 50 degrees Celsius, about −25 degrees Celsius to about 40 degrees Celsius, about −20 degrees Celsius to about 30 degrees Celsius, about −20 degrees Celsius to about 20 degrees Celsius, or of about −10 degrees Celsius to about ten degrees Celsius when determined in accordance with ASTM D3418-97 as described herein below. In one aspect, the glass transition temperature of the thermoplastic elastomer is selected such that articles incorporating the coated yarns disclosed herein, wherein the coated yarns comprise a coating material comprising the thermoplastic elastomer, have a thermoplastic material above its glass transition temperature during normal wear when incorporated into an article of footwear (i.e., is more rubbery and less brittle).

In one aspect, the thermoplastic elastomer comprises: (a) a plurality of first segments; (b) a plurality of second segments; and, optionally, (c) a plurality of third segments. In various aspects, the thermoplastic elastomer is a block copolymer. In some aspects, the thermoplastic elastomer is a segmented copolymer. In further aspects, the thermoplastic elastomer is a random copolymer. In still further aspects, the thermoplastic elastomer is a condensation copolymer.

In a further aspect, the thermoplastic elastomer has a weight average molecular weight of about 50,000 Daltons to about 1,000,000 Daltons, about 50,000 Daltons to about 500,000 Daltons, about 75,000 Daltons to about 300,000 Daltons, or about 100,000 Daltons to about 200,000 Daltons.

In a further aspect, the thermoplastic elastomer has a ratio of first segments to second segments from about 1:1 to about 1:2 based on the weight of each of the first segments and the second segments, or of about 1:1 to about 1:1.5 based on the weight of each of the first segments and the second segments.

In a further aspect, the thermoplastic elastomer has a ratio of first segments to third segments from about 1:1 to about 1:5 based on the weight of each of the first segments and the third segments, about 1:1 to about 1:3 based on the weight of each of the first segments and the third segments, about 1:1 to about 1:2 based on the weight of each of the first segments and the third segments, or about 1:1 to about 1:3 based on the weight of each of the first segments and the third segments.

In a further aspect, the thermoplastic elastomer has first segments derived from a first component having a number-average molecular weight of about 250 Daltons to about 6,000 Daltons, about 400 Daltons to about 6,000 Daltons, about 350 Daltons to about 5,000 Daltons, or about 500 Daltons to about 3,000 Daltons.

In some aspects, the thermoplastic elastomer comprises phase-separated domains. For example, a plurality of first segments can phase-separate into domains comprising primarily the first segments. Moreover, a plurality of second segments derived from segments having a different chemical structure can phase-separate into domains comprising primarily the second segments. In some aspects, the first segments can comprise hard segments, and the second segments can comprise soft segments. In other aspects, the thermoplastic elastomer can comprise phase-separated domains comprising a plurality of first copolyester units.

In one aspect, prior to thermoforming, a polymeric composition has a glass transition temperature of from about 20 degrees Celsius to about −60 degrees Celsius. In one aspect, prior to thermoforming, a polymeric composition has a Taber Abrasion Resistance of from about 10 milligrams to about 40 milligrams as determined by ASTM D3389. In one aspect, prior to thermoforming, a polymeric composition has a Durometer Hardness (Shore A) of from about 60 to about 90 as determined by ASTM D2240. In one aspect, prior to thermoforming, a polymeric composition has a specific gravity of from about 0.80 g/cm³ to about 1.30 g/cm³ as determined by ASTM D792. In one aspect, prior to thermoforming, a polymeric composition has a melt flow index of about two grams/ten minutes to about 50 grams/ten minutes at 160 degrees Celsius using a test weight of 2.16 kilograms. In one aspect, prior to thermoforming, a polymeric composition has a melt flow rate greater than about two grams/ten minutes at 190 degrees Celsius or 200 degrees Celsius when using a test weight of ten kilograms. In one aspect, prior to thermoforming, the polymeric composition has a modulus of about 1 megapascal to about 500 megapascals.

### Example Thermoplastic Polyurethane Elastomers

In certain aspects, the thermoplastic elastomer, as used for the coating of the first yarn in some aspects herein, is a thermoplastic polyurethane (TPU) elastomer. The thermoplastic polyurethane elastomer may be a thermoplastic block polyurethane copolymer. The thermoplastic polyurethane copolymer may be a copolymer comprising hard segments and soft segments, including blocks of hard segments and blocks of soft segments. The hard segments may comprise or consist of isocyanate segments. In the same or alternative aspects, the soft segments may comprise or consist of polyether segments, or polyester segments, or a combination of polyether segments and polyester segments. In one aspect, the thermoplastic material, or the polymeric component of the thermoplastic material, may comprise or consist essentially of an elastomeric thermoplastic polyurethane hard segments and soft segments, such as an elastomeric thermoplastic polyurethane having repeating blocks of hard segments and repeating blocks of soft segments.

In aspects, one or more of the thermoplastic polyurethane elastomers can be produced by polymerizing one or more isocyanates with one or more polyols to produce copolymer chains having carbamate linkages, such as (—N(CO)O—), as illustrated below in Formula 1, where the isocyanate(s) each preferably include two or more isocyanate (—NCO) groups per molecule, such as two, three, or four isocyanate groups per molecule (although single-functional isocyanates can also be optionally included, e.g., as chain-terminating units).

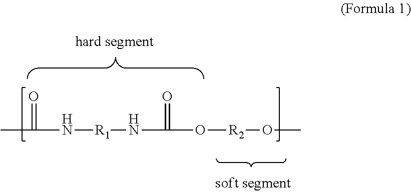

In these aspects, each R₁ and R₂ independently is an aliphatic or aromatic segment. Optionally, each R₂ can be a hydrophilic segment. Unless otherwise indicated, any of the functional groups or chemical compounds described herein can be substituted or unsubstituted. A “substituted” group or chemical compound, such as an alkyl, alkenyl, alkynyl, cycloalkyl, cycloalkenyl, aryl, heteroaryl, alkoxyl, ester, ether, or carboxylic ester, referring to an alkyl, alkenyl, alkynyl, cycloalkyl, cycloalkenyl, aryl, heteroaryl, alkoxyl, ester, ether, or carboxylic ester group, has at least one hydrogen radical that is substituted with a non-hydrogen radical (i.e., a substituent). Examples of non-hydrogen radicals (or substituents) include, but are not limited to, alkyl, cycloalkyl, alkenyl, cycloalkenyl, alkynyl, ether, aryl, heteroaryl, heterocycloalkyl, hydroxyl, oxy (or oxo), alkoxyl, ester, thioester, acyl, carboxyl, cyano, nitro, amino, amido, sulfur, and halo. When a substituted alkyl group includes more than one non-hydrogen radical, the substituents can be bound to the same carbon or two or more different carbon atoms.

Additionally, the isocyanates can also be chain-extended with one or more chain extenders to bridge two or more isocyanates. This can produce polyurethane copolymer chains, as illustrated below in Formula 2, wherein R₃ includes the chain extender. As with each R₁ and R₃, each R₃ independently is an aliphatic or aromatic segment.

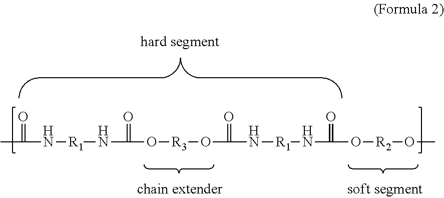

Each segment R₁, or the first segment, in Formulas 1 and 2 can independently include a linear or branched C₃₋₃₀ segment, based on the particular isocyanate(s) used, and can be aliphatic, aromatic, or include a combination of aliphatic portions(s) and aromatic portion(s). The term “aliphatic” refers to a saturated or unsaturated organic molecule that does not include a cyclically conjugated ring system having delocalized pi electrons. In comparison, the term “aromatic” refers to a cyclically conjugated ring system having delocalized pi electrons, which exhibits greater stability than a hypothetical ring system having localized pi electrons.

Each segment R₁ can be present in an amount of five percent to 85 percent by weight, from five percent to 70 percent by weight, or from ten percent to 50 percent by weight, based on the total weight of the reactant monomers.

In aliphatic aspects (from aliphatic isocyanate[s]), each segment R₁ can include a linear aliphatic group, a branched aliphatic group, a cycloaliphatic group, or combinations thereof. For instance, each segment R₁ can include a linear or branched C₃₋₂₀ alkylene segment (e.g., C₄₋₁₅ alkylene or C₆₋₁₀ alkylene), one or more C₃₋₈ cycloalkylene segments (e.g., cyclopropyl, cyclobutyl, cyclopentyl, cyclohexyl, cycloheptyl, or cyclooctyl), and combinations thereof.

Examples of suitable aliphatic diisocyanates for producing the polyurethane copolymer chains include hexamethylene diisocyanate (HDI), isophorone diisocyanate (IPDI), butylenediisocyanate (HMDI), 2,2,4-tri (BDI), bisisocyanatocyclohexylmethane methylhexamethylene diisocyanate (TMDI), bisisocyanatomethylcyclohexane, bisisocyanatomethyltricyclodecane, norbornane diisocyanate (N DI), cyclohexane diisocyanate (CHDI), 4,4′-dicyclohexylmethane diisocyanate (H12MDI), diisocyanatododecane, lysine diisocyanate, and combinations thereof.

In aromatic aspects (from aromatic isocyanate[s]), each segment R₁ can include one or more aromatic groups, such as phenyl, naphthyl, tetrahydronaphthyl, phenanthrenyl, biphenylenyl, indanyl, indenyl, anthracenyl, and fluorenyl. Unless otherwise indicated, an aromatic group can be an unsubstituted aromatic group or a substituted aromatic group, and can also include heteroaromatic groups. “Heteroaromatic” refers to monocyclic or polycyclic (e.g., fused bicyclic and fused tricyclic) aromatic ring systems, where one to four ring atoms are selected from oxygen, nitrogen, or sulfur, and the remaining ring atoms are carbon, and where the ring system is joined to the remainder of the molecule by any of the ring atoms. Examples of suitable heteroaryl groups include pyridyl, pyrazinyl, pyrimidinyl, pyrrolyl, pyrazolyl, imidazolyl, thiazolyl, tetrazolyl, oxazolyl, isooxazolyl, thiadiazolyl, oxadiazolyl, furanyl, quinolinyl, isoquinolinyl, benzoxazolyl, benzimidazolyl, and benzothiazolyl.

Examples of suitable aromatic diisocyanates for producing the polyurethane copolymer chains include toluene diisocyanate (TDI), TDI adducts with trimethyloylpropane TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (N DI), 1,5-tetrahydronaphthalene diisocyanate, para-phenylene diisocyanate (PPDI), 3,3′-dimethyldiphenyl-4, 4′-diisocyanate (DDDI), 4,4′-dibenzyl diisocyanate (DBDI), 4-chloro-1,3-phenylene diisocyanate, and combinations thereof. In some aspects, the copolymer chains are substantially free of aromatic groups.

In particular aspects, the polyurethane copolymer chains are produced from diisocyanates including HMDI, TDI, MDI, H12 aliphatics, and combinations thereof. For example, the coated fiber as described herein of the present disclosure can comprise one or more polyurethane copolymer chains that are produced from diisocynates including HMDI, TDI, MDI, H₁₂ aliphatics, and combinations thereof.

In certain aspects, polyurethane chains that are cross-linked (e.g., partially cross-linked polyurethane copolymers that retain thermoplastic properties) or which can be cross-linked can be used in accordance with the present disclosure. It is possible to produce cross-linked or cross-linkable polyurethane copolymer chains using multi-functional isocyanates. Examples of suitable triisocyanates for producing the polyurethane copolymer chains include TDI, HDI, and IPDI adducts with trimethyloylpropane (TMP), uretdiones (i.e., dimerized isocyanates), polymeric MDI, and combinations thereof.

Segment R₃ in Formula 2 can include a linear or branched C₂-C₁₀ segment, based on the particular chain extender polyol used, and can be, for example, aliphatic, aromatic, or polyether. Examples of suitable chain extender polyols for producing the polyurethane copolymer chains include ethylene glycol, lower oligomers of ethylene glycol (e.g., diethylene glycol, triethylene glycol, and tetraethylene glycol), 1,2-propylene glycol, 1,3-propylene glycol, lower oligomers of propylene glycol (e.g., dipropylene glycol, tripropylene glycol, and tetrapropylene glycol), 1,4-butylene glycol, 2,3-butylene glycol, 1,6-hexanediol, 1,8-octanediol, neopentyl glycol, 1,4-cyclohexanedimethanol, 2-ethyl-1,6-hexanediol, 1-methyl-1,3-propanediol, 2-methyl-1,3-propanediol, dihydroxyalkylated aromatic compounds (e.g., bis(2-hydroxyethyl) ethers of hydroquinone and resorcinol, xylene-a,a-diols, bis(2-hydroxyethyl) ethers of xylene-a,a-diols, and combinations thereof).

Segment R₂ in Formula 1 and 2 can include a polyether group, a polyester group, a polycarbonate group, an aliphatic group, or an aromatic group. Each segment R₂ can be present in an amount of five percent to 85 percent by weight, from five percent to 70 percent by weight, or from ten percent to 50 percent by weight, based on the total weight of the reactant monomers.

Optionally, in some examples, the thermoplastic polyurethane elastomer is a thermoplastic polyurethane having a relatively high degree of hydrophilicity. For example, the thermoplastic polyurethane can be a thermoplastic polyether polyurethane in which segment R₂ in Formulas 1 and 2 includes a polyether group, a polyester group, a polycarbonate group, an aliphatic group, or an aromatic group, wherein the aliphatic group or aromatic group is substituted with one or more pendant groups having a relatively greater degree of hydrophilicity (i.e., relatively “hydrophilic” groups). The relatively “hydrophilic” groups can be selected from the group consisting of hydroxyl, polyether, polyester, polylactone (e.g., polyvinylpyrrolidone [PVP]), amino, carboxylate, sulfonate, phosphate, ammonium (e.g., tertiary and quaternary ammonium), zwitterion (e.g., a betaine, such as poly(carboxybetaine) (pCB), and ammonium phosphonates such as phosphatidylcholine), and combinations thereof. In such examples, this relatively hydrophilic group or segment of R₂ can form portions of the polyurethane backbone, or can be grafted to the polyurethane backbone as a pendant group. In some examples, the pendant hydrophilic group or segment can be bonded to the aliphatic group or aromatic group through a linker. Each segment R₂ can be present in an amount of five percent to 85 percent by weight, from five percent to 70 percent by weight, or from ten percent to 50 percent by weight, based on the total weight of the reactant monomers.

In some examples, at least one R₂ segment of the thermoplastic polyurethane elastomer includes a polyether segment (i.e., a segment having one or more ether groups). Suitable polyethers include, but are not limited to, polyethylene oxide (PEO), polypropylene oxide (PPO), polytetrahydrofuran (PTHF), polytetramethylene oxide (P TmO), and combinations thereof. The term “alkyl” as used herein refers to straight-chained and branched saturated hydrocarbon groups containing one to thirty carbon atoms, for example, one to twenty carbon atoms, or one to ten carbon atoms. The term Cₙ, means the alkyl group has “n” carbon atoms. For example, C₄ alkyl refers to an alkyl group that has four carbon atoms. C₁₋₇ alkyl refers to an alkyl group having a number of carbon atoms encompassing the entire range (i.e., one to seven carbon atoms), as well as all subgroups (e.g., 1-6, 2-7, 1-5, 3-6, 1, 2, 3, 4, 5, 6, and 7 carbon atoms). Non-limiting examples of alkyl groups include methyl, ethyl, n-propyl, isopropyl, n-butyl, sec-butyl (2-methylpropyl), t-butyl (1,1-dimethylethyl), 3,3-dimethylpentyl, and 2-ethylhexyl. Unless otherwise indicated, an alkyl group can be an unsubstituted alkyl group or a substituted alkyl group.

In some examples of the thermoplastic polyurethane elastomer, the at least one R₂ segment includes a polyester segment. The polyester segment can be derived from the polyesterification of one or more dihydric alcohols (e.g., ethylene glycol, 1,3-propylene glycol, 1,2-propylene glycol, 1,4-butanediol, 1,3-butanediol, 2-methylpentanediol-1,5,diethylene glycol, 1,5-pentanediol, 1,5-hexanediol, 1,2-dodecanediol, cyclohexanedimethanol, and combinations thereof) with one or more dicarboxylic acids (e.g., adipic acid, succinic acid, sebacic acid, suberic acid, methyladipic acid, glutaric acid, pimelic acid, azelaic acid, thiodipropionic acid, citraconic acid, and combinations thereof). The polyester also can be derived from polycarbonate prepolymers, such as poly(hexamethylene carbonate) glycol, poly(propylene carbonate) glycol, poly(tetramethylene carbonate)glycol, and poly(nonanemethylene carbonate) glycol. Suitable polyesters can include, for example, polyethylene adipate (PEA), poly(1,4-butylene adipate), poly(tetramethylene adipate), poly(hexamethylene adipate), polycaprolactone, polyhexam ethylene carbonate, poly(propylene carbonate), poly(tetramethylene carbonate), poly(nonanemethylene carbonate), and combinations thereof.

In various aspects of the thermoplastic polyurethane elastomer, at least one R₂ segment includes a polycarbonate segment. The polycarbonate segment can be derived from the reaction of one or more dihydric alcohols (e.g., ethylene glycol, 1,3-propylene glycol, 1,2-propylene glycol, 1,4-butanediol, 1,3-butanediol, 2-methylpentanediol-1,5, diethylene glycol, 1,5-pentanediol, 1,5-hexanediol, 1,2-dodecanediol, cyclohexanedimethanol, and combinations thereof) with ethylene carbonate.

In various examples of the thermoplastic polyurethane elastomer, at least one R₂ segment can include an aliphatic group substituted with one or more groups having a relatively greater degree of hydrophilicity, i.e., a relatively “hydrophilic” group. The one or more relatively hydrophilic group can be selected from the group consisting of hydroxyl, polyether, polyester, polylactone (e.g., polyvinylpyrrolidone), amino, carboxylate, sulfonate, phosphate, ammonium (e.g., tertiary and quaternary ammonium), zwitterion (e.g., a betaine, such as poly(carboxybetaine) (pCB), and ammonium phosphonates such as phosphatidylcholine), and combinations thereof. In some examples, the aliphatic group is linear and can include, for example, a C1_20 alkylene chain or a C1_20 alkenylene chain (e.g., methylene, ethylene, propylene, butylene, pentylene, hexylene, heptylene, octylene, nonylene, decylene, undecylene, dodecylene, tridecylene, ethenylene, propenylene, butenylene, pentenylene, hexenylene, heptenylene, octenylene, nonenylene, decenylene, undecenylene, dodecenylene, and tridecenylene). The term “alkylene” refers to a bivalent hydrocarbon. The term means that the alkylene group has “n” carbon atoms. For example, C₁₋₆ alkylene refers to an alkylene group having, e.g., one, two, three, four, five, or six carbon atoms. The term “alkenylene” refers to a bivalent hydrocarbon having at least one double bond.

In some cases, at least one R₂ segment includes an aromatic group substituted with one or more relatively hydrophilic group. The one or more hydrophilic groups can be selected from the group consisting of hydroxyl, polyether, polyester, polylactone (e.g., polyvinylpyrrolidone), amino, carboxylate, sulfonate, phosphate, ammonium (e.g., tertiary and quaternary ammonium), zwitterionic (e.g., a betaine, such as poly(carboxybetaine) (pCB), and ammonium phosphonate groups such as phosphatidylcholine), and combinations thereof. Suitable aromatic groups include, but are not limited to, phenyl, naphthyl, tetrahydronaphthyl, phenanthrenyl, biphenylenyl, indanyl, indenyl, anthracenyl, fluorenylpyridyl, pyrazinyl, pyrimidinyl, pyrrolyl, pyrazolyl, imidazolyl, thiazolyl, tetrazolyl, oxazolyl, isooxazolyl, thiadiazolyl, oxadiazolyl, furanyl, quinolinyl, isoquinolinyl, benzoxazolyl, benzimidazolyl, and benzothiazolyl groups, and combinations thereof.

In various aspects, the aliphatic and aromatic groups can be substituted with one or more relatively hydrophilic and/or charged pendant groups. In some aspects, the pendant hydrophilic group includes one or more (e.g., two, three, four, five, six, seven, eight, nine, ten, or more) hydroxyl groups. In various aspects, the pendant hydrophilic group includes one or more (e.g., two, three, four, five, six, seven, eight, nine, ten, or more) amino groups. In some cases, the pendant hydrophilic group includes one or more (e.g., two, three, four, five, six, seven, eight, nine, ten, or more) carboxylate groups. For example, the aliphatic group can include one or more polyacrylic acid groups. In some cases, the pendant hydrophilic group includes one or more (e.g., two, three, four, five, six, seven, eight, nine, ten, or more) sulfonate groups. In some cases, the pendant hydrophilic group includes one or more (e.g., two, three, four, five, six, seven, eight, nine, ten, or more) phosphate groups. In some examples, the pendant hydrophilic group includes one or more ammonium groups (e.g., tertiary and/or quaternary ammonium). In other examples, the pendant hydrophilic group includes one or more zwitterionic groups (e.g., a betaine, such as poly(carboxybetaine) (pCB), and ammonium phosphonate groups such as a phosphatidylcholine group).

In some aspects, the R₂ segment can include charged groups that are capable of binding to a counterion to ionically cross-link the thermoplastic elastomer and form ionomers. In these aspects, for example, R₂ is an aliphatic or aromatic group having pendant amino, carboxylate, sulfonate, phosphate, ammonium, or zwitterionic groups, or combinations thereof.

In various cases when a pendant hydrophilic group is present, the pendant “hydrophilic” group is at least one polyether group, such as two polyether groups. In other cases, the pendant hydrophilic group is at least one polyester. In various cases, the pendant hydrophilic group is a polylactone group (e.g., polyvinylpyrrolidone). Each carbon atom of the pendant hydrophilic group can optionally be substituted with, e.g., a C₁₋₆ alkyl group. In some of these aspects, the aliphatic and aromatic groups can be graft polymeric groups, wherein the pendant groups are homopolymeric groups (e.g., polyether groups, polyester groups, or polyvinylpyrrolidone groups).

In some aspects, the pendant hydrophilic group is a polyether group (e.g., a polyethylene oxide group or a polyethylene glycol group), a polyvinylpyrrolidone group, a polyacrylic acid group, or combinations thereof.

As described herein, the thermoplastic polyurethane elastomer can be physically cross-linked through, e.g., nonpolar or polar interactions between the urethane or carbamate groups on the polymers (the hard segments). In these aspects, component R₁ in Formula 1 and components R₁ and R₃ in Formula 2 form the portion of the polymer often referred to as the “hard segment,” and component R₂ forms the portion of the polymer often referred to as the “soft segment.” In these aspects, the soft segment can be covalently bonded to the hard segment. In some examples, the thermoplastic polyurethane elastomer having physically cross-linked hard and soft segments can be a hydrophilic thermoplastic polyurethane elastomer (i.e., a thermoplastic polyurethane elastomer including hydrophilic groups, as disclosed herein).

In one aspect, prior to thermoforming, the thermoplastic polyurethane elastomer is an aromatic polyester thermoplastic elastomeric polyurethane or an aliphatic polyester thermoplastic elastomeric polyurethane having the following properties: (1) a glass transition temperature of from about 20 degrees Celsius to about −60 degrees Celsius; (2) a Taber Abrasion Resistance of from about ten milligrams to about 40 milligrams, as determined by ASTM D3389; (3) a Durometer Hardness (Shore A) of from about 60 to about 90 as determined by ASTM D2240; (4) a specific gravity of from about 0.80 g/cm³ to about 1.30 g/cm³, as determined by ASTM D792; (5) a melt flow index of about two grams/ten minutes to about 50 grams/ten minutes at 160 degrees Celsius using a test weight of 2.16 kilograms; (6) a melt flow rate greater than about two grams/ten minutes at 190 degrees Celsius or 200 degrees Celsius when using a test weight of ten kilograms; and (7) a modulus of about one megapascal to about 500 megapascals.

Commercially available thermoplastic polyurethane elastomers having greater hydrophilicity suitable for the present use include, but are not limited to, those under the tradename “TECOPHILIC,” such as TG-500, TG-2000, SP-80A-150, SP-93A-100, SP-60D60 (Lubrizol, Countryside, IL), “ESTANE” (e.g., 58238 and T470A; Lubrizol, Countryside, IL), and “ELASTOLLAN” (e.g., 9339, 1370A, and BASF).

In various aspects, the thermoplastic polyurethane elastomer can be partially covalently cross-linked, as previously described herein.

### Example Thermoplastic Styrenic Copolymer Elastomers

In certain aspects, the thermoplastic elastomer is a thermoplastic elastomeric styrenic copolymer. Examples of these copolymers include, but are not limited to, styrene butadiene styrene (SBS) block copolymer, a styrene ethylene/butylene styrene (SEBS) resin, a polyacetal resin (POM) a styrene acrylonitrile resin (SAN), or a blend, alloy, or compound thereof. Exemplary commercially available thermoplastic elastomeric styrenic copolymers include MONOPRENE IN5074, SP066070, and SP16975 (Teknor Apex, Pawtucket, RI, USA), which are styrene ethylene/butylene styrene (SEBS) resins. In some aspects, blends, alloys, and compounds should be melt-compatible or can be compatibilized with additives, oils, or grafted chemical moieties in order to achieve miscibility.

In one aspect, the thermoplastic elastomeric styrenic copolymer includes at least one block as illustrated below in Formula 3:

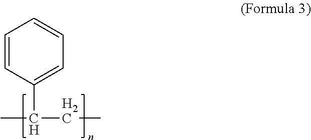

In another aspect, the thermoplastic elastomeric styrenic copolymer can be an SBS block copolymer comprising a first polystyrene block (block m of Formula 4), a polybutadiene block (block o of Formula 4), and a second polystyrene block (block p of Formula 4), wherein the SBS block copolymer has the general structure shown in Formula 4 below:

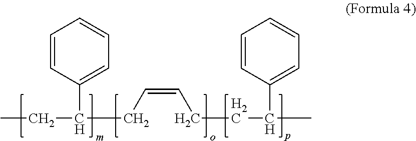

In another aspect, the thermoplastic elastomeric styrenic copolymer can be an SEBS block copolymer comprising a first polystyrene block (block x of Formula 5), a polyolefin block (block y of Formula 5), wherein the polyolefin block comprises alternating polyethylene blocks (block v of Formula 5) and polybutylene blocks (block w of Formula 4), and a second polystyrene block (block z of Formula 5) as seen in Formula 5 below:

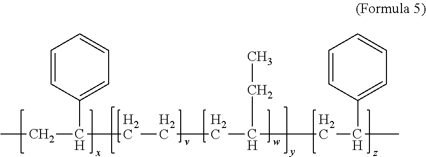

In one aspect, SEBS polymers have a density from about 0.88 grams per cubic centimeter to about 0.92 grams per cubic centimeter. In a further aspect, SEBS polymers can be as much as 15 to 25 percent less dense than cross-linked rubbers, cross-linked polyurethanes, and thermoplastic polyurethane materials. In a further aspect, a less dense coating composition offers weight savings and per part cost savings for the same material of volume employed while achieving similar performance.

Reference to “a chemical compound” refers to one or more molecules of the chemical compound, rather than being limited to a single molecule of the chemical compound. Furthermore, the one or more molecules can or cannot be identical, so long as they fall under the category of the chemical compound. Thus, for example, “a polyamide” is interpreted to include one or more polymer molecules of the polyamide, where the polymer molecules can or cannot be identical (e.g., different molecular weights and/or isomers).

The terms “at least one” and “one or more of” an element are used interchangeably, and have the same meaning that includes a single element and a plurality of the elements, and can also be represented by the suffix “(s)” at the end of the element. For example, “at least one polyamide,” “one or more polyamides,” and “polyamide(s)” can be used interchangeably and have the same meaning.

Unless otherwise specified, temperatures referred to herein are determined at standard atmospheric pressure (i.e., one ATM).

### Property Analysis and Characterization Procedures

Evaluation of various properties and characteristics described herein are by various testing procedures, as described below.

Sample Coefficient of Friction. The static or dynamic coefficient of friction (COF) of a textile or plaque sample can be determined using test method ASTM D1894. In this method, a sample is cut to size and mounted on the sled, and a 100 gram weight plate is placed on the sled. During the test, the weighted sled is pulled across a test surface of the material being tested. For example, static and dynamic or wet and dry COF may be determined by pulling the sled across a concrete surface to determine the COF of the sample and concrete. The coefficient of friction of the sample against that surface is captured by recording the normal force (100 grams plus sled weight) and measuring the applied force required to drag the sled across the test surface. The coefficient of friction (COF) is then calculated from the ratio of the two forces. Dry COF is determined by testing a dry sample against a dry testing surface, and wet COF is determined by testing a sample wetted with water by soaking it in room temperature water for ten minutes against a test surface wetted with room temperature water.

Textile-Ball Coefficient of Friction Test. The static and dynamic coefficient of friction (COF) of a sample prepared using the Component Sampling Procedure or the Textile Sampling Procedure described below against a sample from a panel of a “MERLIN” football (Nike Inc., Beaverton, OR, USA) can be determined using a modified version of test method ASTM D1894 as described for the Sample Coefficient of Friction. In this method, the sample is cut to size and mounted on an acrylic substrate, and the ball material is cut to size and mounted on the sled. Once the ball material has been mounted on the sled, the sled has a contact footprint of 3.9 inches by one inch, and a weight of approximately 0.402 kilograms. During the test, the sample and ball material are positioned with the external-facing surface of the ball material contacting the surface of the sample which is intended form the external-facing surface of an article of footwear, and the sled is pulled across the sample. Dry samples and dry ball material are used to determine the static or dynamic dry COF. To determine the static or dynamic wet COF, the sample and the ball material are both soaked in room temperature water for ten minutes immediately prior to testing. Each measurement is repeated at least three times, and the results of the runs are averaged.

Melting and Glass Transition Temperature Test. The melting temperature and/or glass transition temperature are determined for a sample prepared according to Material Sampling Procedure described below, using a commercially available Differential Scanning calorimeter (“DSC”) in accordance with ASTM D3418-97. Briefly, a 10-60 milligram sample is placed into an aluminum DSC pan, and then the lid is sealed with a crimper press. The DSC is configured to scan from 100 degrees Celsius to 225 degrees Celsius with a 20 degree Celsius/minute heating rate, to hold at 225 degrees Celsius for two minutes, and then to cool down to 25 degrees Celsius at a rate of 20 degrees Celsius/minute. The DSC curve created from this scan is then analyzed using standard techniques to determine the glass transition temperature and the melting temperature. Melting enthalpy is calculated by integrating the melting endotherm and normalizing by the mass of the sample. Crystallization enthalpy upon cooling is calculated by integrating the cooling endotherm and normalizing by the mass of the sample.

Yarn Tenacity and Elongation Test. Tenacity and elongation of the yarn sample are determined according to the test method detailed in EN ISO 2062 with the pre-load set to five grams. Elongation is recorded at the maximum tensile force value applied prior to breaking. In some aspects, tenacity is calculated as the ratio of load required to break the specimen to the linear density of the specimen.

Durometer Hardness Test. The hardness of a material can be determined for a sample according to the test method detailed in ASTM D-2240 Durometer Hardness using a Shore A scale.

### Sampling Procedures

Using the Tests described above, various properties of the materials disclosed herein and articles formed therefrom can be characterized using samples prepared with the following sampling procedures:

Component Sampling Procedure. This procedure can be used to obtain a sample of a material from a component of an article of footwear, an article of footwear, a component of an article of apparel, an article of apparel, a component of an article of sporting equipment, or an article of sporting equipment, including a sample of a polymeric composition or of a textile, or a portion of a textile, such as a thermoformed network. A sample including the material in a non-wet state (e.g., at 25 degrees Celsius and 20 percent relative humidity) is cut from the article or component using a blade. If the material is bonded to one or more additional materials, the procedure can include separating the additional materials from the material to be tested. For example, to test a material on a ground-facing surface of a sole structure, the opposite surface can be skinned, abraded, scraped, or otherwise cleaned to remove any adhesives, yarns, fibers, foams, and the like, which are affixed to the material to be tested. The resulting sample includes the material and not any additional materials bonded to the material.

The sample is taken at a location along the article or component that provides a substantially constant material thickness for the material as present on the article or component (within plus or minus ten percent of the average material thickness), such as, for an article of footwear, in a forefoot region, midfoot region, or a heel region of a ground-facing surface. For many of the test protocols described above, a sample having a surface area of four square centimeters (cm²) is used. The sample is cut into a size and shape (e.g., a dog-bone-shaped sample) to fit into the testing apparatus. In cases where the material is not present on the article or component in any segment having a four square centimeter surface area, and/or where the material thickness is not substantially constant for a segment having a four square centimeter surface area, sample sizes with smaller cross-sectional surface areas can be taken, and the area-specific measurements are adjusted accordingly.

Textile Sampling Procedure. A textile to be tested is stored at room temperature (20 degrees Celsius to 24 degrees Celsius) for 24 hours prior to testing. The textile sample is cut to size, as dictated by the test method to be used, with minimal tension at approximately room temperature (e.g., 20 degrees Celsius).

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A knitted upper for an article of footwear, the knitted upper comprising: a first set of raised elements extending in a first direction on a lateral side of the knitted upper; and a second set of raised elements extending in a second direction on a medial side of the knitted upper, the second direction being different from the first direction, each of the first set of raised elements and the second set of raised elements comprising a thermoformed network of interlooped yarns.

Clause 2. The knitted upper for the article of footwear according to clause 1, wherein the first direction is from a toe area of the knitted upper toward a heel area of the knitted upper.

Clause 3. The knitted upper for the article of footwear according to any of clauses 1 through 2, wherein the second direction is from a lower area of the knitted upper toward a throat area of the knitted upper.

Clause 4. The knitted upper for the article of footwear according to any of clauses 1 through 3, wherein each raised element of the first set of raised elements is separated from an adjacent raised element by an intervening segment of knit material without raised elements, at least a portion of the intervening segment of knit material without raised elements comprising the thermoformed network of interlooped yarns.

Clause 5. The knitted upper for the article of footwear according to any of clauses 1 through 4, wherein each raised element of the second set of raised elements is separated from an adjacent raised element by an intervening segment of knit material without raised elements, at least a portion of the intervening segment of knit material without raised elements comprising the thermoformed network of interlooped yarns.

Clause 6. The knitted upper for the article of footwear according to any of clauses 1 through 5, wherein the thermoformed network of interlooped yarns comprises a first yarn having a core and a coating, the coating at least partially surrounding the core, and wherein the coating interconnects the thermoformed network of interlooped yarns by surrounding at least a portion of the core and occupying at least a portion of spaces between yarns in the thermoformed network of interlooped yarns.

Clause 7. The knitted upper for the article of footwear according to any of clauses 1 through 6, wherein each raised element of the first set of raised elements and each raised element of the second set of raised elements extend in a z-direction away from an outer surface of the knitted upper.

Clause 8. The knitted upper for the article of footwear according to any of clauses 1 through 7, wherein a first raised element of the first set of raised elements has a first height in the z-direction, and wherein a second raised element of the first set of raised elements has a second height in the z-direction, the second height different from the first height.

Clause 9. The knitted upper for the article of footwear according to any of clauses 1 through 8, wherein a first raised element of the second set of raised elements has a first height in the z-direction, and wherein a second raised element of the second set of raised elements has a second height in the z-direction, the second height different from the first height.

Clause 10. An article of footwear comprising: a knitted upper; and a sole structure secured to the knitted upper, the knitted upper comprising: a first set of raised elements extending in a first direction on a lateral side of the knitted upper; and a second set of raised elements extending in a second direction from a lower area of the knitted upper toward a throat area of the knitted upper on a medial side of the knitted upper, the second direction different from the first direction, each of the first set of raised elements and the second set of raised elements comprising a thermoformed network of interlooped yarns.

Clause 11. The article of footwear according to clause 10, wherein the first direction is from a toe area of the knitted upper toward a heel area of the knitted upper.

Clause 12. The article of footwear according to any of clauses 10 through 11, wherein the sole structure comprises one or more ground-engaging cleats extending from a lower surface of the sole structure.

Clause 13. The article of footwear according to any of clauses 10 through 12, wherein the thermoformed network of interlooped yarns comprises a first yarn having a core and a coating, the coating at least partially surrounding the core, and wherein the coating interconnects the thermoformed network of interlooped yarns by surrounding at least a portion of the core and occupying at least a portion of spaces between yarns in the thermoformed network of interlooped yarns.

Clause 14. The article of footwear according to clause 13, wherein the coating comprises a thermoplastic elastomer.

Clause 15. The article of footwear according to clause 14, wherein the thermoplastic elastomer comprises one of a thermoplastic polyurethane or a styrene ethylene/butylene styrene.

Clause 16. The article of footwear according to any of clauses 10 through 15, wherein one or more of the first set of raised elements and the second set of raised elements comprise a second yarn, the second yarn comprising a high-tenacity yarn having a tenacity of about 5 grams/denier or greater.

Clause 17. The article of footwear according to any of clauses 10 through 16, wherein each raised element of the first set of raised elements and each raised element of the second set of raised elements extend in a z-direction away from an outer surface of the knitted upper.

Clause 18. The article of footwear according to any of clauses 10 through 17, wherein one or more of the first set of raised elements and the second set of raised elements include a first raised element having a first height in the z-direction and a second raised element having a second height in the z-direction, the second height different from the first height.

Clause 19. A method of manufacturing a knitted upper for an article of footwear, the method comprising: knitting at least a first yarn to form the knitted upper; thermoforming a first set of raised elements on a lateral side of the knitted upper, the first set of raised elements extending in a first direction on the lateral side of the knitted upper; and thermoforming a second set of raised elements on a medial side of the knitted upper, the second set of raised elements extending in a second direction on the medial side of the knitted upper, the second direction different from the first direction, each of the first set of raised elements and each of the second set of raised elements comprising a thermoformed network of interlooped yarns each having a core, such that a thermoplastic elastomer interconnects the interlooped yarns by surrounding at least a portion of each core and occupying at least a portion of spaces between yarns in the thermoformed network of interlooped yarns.

Clause 20. The method of manufacturing the knitted upper for the article of footwear according to clause 19, wherein the first direction is from a toe area of the knitted upper toward a heel area of the knitted upper, and wherein the second direction is from a lower area of the knitted upper toward a throat area of the knitted upper.

Clause 21. The method of manufacturing the knitted upper for the article of footwear according to any of clauses 19 through 20, wherein thermoforming the first set of raised elements and the second set of raised elements comprises: positioning a first surface of the knitted upper adjacent a surface of a first mold plate, the surface having one or more cavities; positioning a second mold plate adjacent an opposite second surface of the knitted upper; and applying one or more of heat and pressure to one or more of the first mold plate and the second mold plate such that the one or more cavities of the first mold plate are at least partially filled with the thermoformed network of interlooped yarns to form the first set of raised elements and the second set of raised elements.

Clause 22. The method of manufacturing the knitted upper for the article of footwear according to clause 21, further comprising forming the article of footwear using the knitted upper such that the first surface of the knitted upper forms an outer surface of the article of footwear.

Clause 23. The method of manufacturing the knitted upper for the article of footwear according to any of clauses 19 through 20, wherein thermoforming the first set of raised elements and the second set of raised elements comprises: positioning a second surface of the knitted upper adjacent a surface of a first mold plate, the surface having one or more projections; positioning a pliable, heat-resistant pad adjacent an opposite first surface of the knitted upper; and applying one or more of heat and pressure to at least the first mold plate such that the one or more projections of the first mold plate push the thermoformed network of interlooped yarns into the pliable, heat-resistant pad to form the first set of raised elements and the second set of raised elements.

Clause 24. The method of manufacturing the knitted upper for the article of footwear according to clause 23, further comprising forming the article of footwear using the knitted upper such that the first surface of the knitted upper forms an outer surface of the article of footwear.

Aspects of the present disclosure have been described with the intent to be illustrative rather than restrictive. Alternative aspects will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

The following clauses are aspects contemplated herein.

Clause 1. A knitted upper for an article of footwear, the knitted upper comprising: a first set of raised elements extending in a first direction on a lateral side of the knitted upper; and a second set of raised elements extending in a second direction on a medial side of the knitted upper, the second direction being different from the first direction, each of the first set of raised elements and the second set of raised elements comprising a thermoformed network of interlooped yarns.

Clause 2. The knitted upper for the article of footwear of clause 1, wherein the first direction is from a toe area of the knitted upper toward a heel area of the knitted upper.

Clause 3. The knitted upper for the article of footwear of clause 2, wherein the second direction is from a lower area of the knitted upper toward a throat area of the knitted upper.

Clause 4. The knitted upper for the article of footwear of clause 1, wherein each raised element of the first set of raised elements is separated from an adjacent raised element by an intervening segment of knit material without raised elements, at least a portion of the intervening segment of knit material without raised elements comprising the thermoformed network of interlooped yarns.

Clause 5. The knitted upper for the article of footwear of clause 1, wherein each raised element of the second set of raised elements is separated from an adjacent raised element by an intervening segment of knit material without raised elements, at least a portion of the intervening segment of knit material without raised elements comprising the thermoformed network of interlooped yarns.

Clause 6. The knitted upper for the article of footwear of clause 1, wherein the thermoformed network of interlooped yarns comprises a first yarn having a core and a coating, the coating at least partially surrounding the core, and wherein the coating interconnects the thermoformed network of interlooped yarns by surrounding at least a portion of the core and occupying at least a portion of spaces between yarns in the thermoformed network of interlooped yarns.

Clause 7. The knitted upper for the article of footwear of clause 1, wherein each raised element of the first set of raised elements and each raised element of the second set of raised elements extend in a z-direction away from an outer surface of the knitted upper.

Clause 8. The knitted upper for the article of footwear of clause 7, wherein a first raised element of the first set of raised elements has a first height in the z-direction, and wherein a second raised element of the first set of raised elements has a second height in the z-direction, the second height different from the first height.

Clause 9. The knitted upper for the article of footwear of clause 7, wherein a first raised element of the second set of raised elements has a first height in the z-direction, and wherein a second raised element of the second set of raised elements has a second height in the z-direction, the second height different from the first height.

Clause 10. An article of footwear comprising: a knitted upper; and a sole structure secured to the knitted upper, the knitted upper comprising: a first set of raised elements extending in a first direction on a lateral side of the knitted upper; and a second set of raised elements extending in a second direction from a lower area of the knitted upper toward a throat area of the knitted upper on a medial side of the knitted upper, the second direction different from the first direction, each of the first set of raised elements and the second set of raised elements comprising a thermoformed network of interlooped yarns.

Clause 11. The article of footwear of clause 10, wherein the first direction is from a toe area of the knitted upper toward a heel area of the knitted upper.

Clause 12. The article of footwear of clause 10, wherein the sole structure comprises one or more ground-engaging cleats extending from a lower surface of the sole structure.

Clause 13. The article of footwear of clause 10, wherein the thermoformed network of interlooped yarns comprises a first yarn having a core and a coating, the coating at least partially surrounding the core, and wherein the coating interconnects the thermoformed network of interlooped yarns by surrounding at least a portion of the core and occupying at least a portion of spaces between yarns in the thermoformed network of interlooped yarns.

Clause 14. The article of footwear of clause 13, wherein the coating comprises a thermoplastic elastomer.

Clause 15. The article of footwear of clause 14, wherein the thermoplastic elastomer comprises one of a thermoplastic polyurethane or a styrene ethylene/butylene styrene.

Clause 16. The article of footwear of clause 10, wherein one or more of the first set of raised elements and the second set of raised elements comprise a second yarn, the second yarn comprising a high-tenacity yarn having a tenacity of about 5 grams/denier or greater.

Clause 17. The article of footwear of clause 10, wherein each raised element of the first set of raised elements and each raised element of the second set of raised elements extend in a z-direction away from an outer surface of the knitted upper.

Clause 18. The article of footwear of clause 17, wherein one or more of the first set of raised elements and the second set of raised elements include a first raised element having a first height in the z-direction and a second raised element having a second height in the z-direction, the second height different from the first height.

Clause 19. A method of manufacturing a knitted upper for an article of footwear, the method comprising: knitting at least a first yarn to form the knitted upper; thermoforming a first set of raised elements on a lateral side of the knitted upper, the first set of raised elements extending in a first direction on the lateral side of the knitted upper; and thermoforming a second set of raised elements on a medial side of the knitted upper, the second set of raised elements extending in a second direction on the medial side of the knitted upper, the second direction different from the first direction, each of the first set of raised elements and each of the second set of raised elements comprising a thermoformed network of interlooped yarns each having a core, such that a thermoplastic elastomer interconnects the interlooped yarns by surrounding at least a portion of each core and occupying at least a portion of spaces between yarns in the thermoformed network of interlooped yarns.

Clause 20. The method of manufacturing the knitted upper for the article of footwear of clause 19, wherein the first direction is from a toe area of the knitted upper toward a heel area of the knitted upper, and wherein the second direction is from a lower area of the knitted upper toward a throat area of the knitted upper.

Clause 21. The method of manufacturing the knitted upper for the article of footwear of clause 19, wherein thermoforming the first set of raised elements and the second set of raised elements comprises: positioning a first surface of the knitted upper adjacent a surface of a first mold plate, the surface having one or more cavities; positioning a second mold plate adjacent an opposite second surface of the knitted upper; and applying one or more of heat and pressure to one or more of the first mold plate and the second mold plate such that the one or more cavities of the first mold plate are at least partially filled with the thermoformed network of interlooped yarns to form the first set of raised elements and the second set of raised elements.

Clause 22. The method of manufacturing the knitted upper for the article of footwear of clause 21 further comprising forming the article of footwear using the knitted upper such that the first surface of the knitted upper forms an outer surface of the article of footwear.

Clause 23. The method of manufacturing the knitted upper for the article of footwear of clause 19, wherein thermoforming the first set of raised elements and the second set of raised elements comprises: positioning a second surface of the knitted upper adjacent a surface of a first mold plate, the surface having one or more projections; positioning a pliable, heat-resistant pad adjacent an opposite first surface of the knitted upper; and applying one or more of heat and pressure to at least the first mold plate such that the one or more projections of the first mold plate push the thermoformed network of interlooped yarns into the pliable, heat-resistant pad to form the first set of raised elements and the second set of raised elements.

Clause 24. The method of manufacturing the knitted upper for the article of footwear of clause 23, further comprising forming the article of footwear using the knitted upper such that the first surface of the knitted upper forms an outer surface of the article of footwear.

What is claimed is:

1. A knitted upper for an article of footwear, the knitted upper comprising:
a first set of raised elements extending in a first direction on a lateral side of the knitted upper; and
a second set of raised elements extending in a second direction on a medial side of the knitted upper, the second direction being different from the first direction, each of the first set of raised elements and the second set of raised elements comprising a thermoformed network of interlooped yarns.

2. The knitted upper for the article of footwear of claim 1, wherein the first direction is from a toe area of the knitted upper toward a heel area of the knitted upper.

3. The knitted upper for the article of footwear of claim 2, wherein the second direction is from a lower area of the knitted upper toward a throat area of the knitted upper.

4. The knitted upper for the article of footwear of claim 1, wherein each raised element of the first set of raised elements and the second set of raised elements is separated from an adjacent raised element by an intervening segment of knit material without raised elements, at least a portion of the intervening segment of knit material without raised elements comprising the thermoformed network of interlooped yarns.

5. The knitted upper for the article of footwear of claim 1, wherein the thermoformed network of interlooped yarns comprises a first yarn having a core and a coating, the coating at least partially surrounding the core, and wherein the coating interconnects the thermoformed network of interlooped yarns by surrounding at least a portion of the core and occupying at least a portion of spaces between yarns in the thermoformed network of interlooped yarns.

6. The knitted upper for the article of footwear of claim 1, wherein each raised element of the first set of raised elements and each raised element of the second set of raised elements extend in a z-direction away from an outer surface of the knitted upper.

7. The knitted upper for the article of footwear of claim 6, wherein a first raised element of the first set of raised elements has a first height in the z-direction, and wherein a second raised element of the first set of raised elements has a second height in the z-direction, the second height different from the first height.

8. The knitted upper for the article of footwear of claim 6, wherein a first raised element of the second set of raised elements has a first height in the z-direction, and wherein a second raised element of the second set of raised elements has a second height in the z-direction, the second height different from the first height.

9. An article of footwear comprising:
a knitted upper; and
a sole structure secured to the knitted upper, the knitted upper comprising:
a first set of raised elements extending in a first direction on a lateral side of the knitted upper; and
a second set of raised elements extending in a second direction from a lower area of the knitted upper toward a throat area of the knitted upper on a medial side of the knitted upper, the second direction different from the first direction, each of the first set of raised elements and the second set of raised elements comprising a thermoformed network of interlooped yarns.

10. The article of footwear of claim 9, wherein the first direction is from a toe area of the knitted upper toward a heel area of the knitted upper.

11. The article of footwear of claim 9, wherein the sole structure comprises one or more ground-engaging cleats extending from a lower surface of the sole structure.

12. The article of footwear of claim 9, wherein the thermoformed network of interlooped yarns comprises a first yarn having a core and a coating, the coating at least partially surrounding the core, and wherein the coating interconnects the thermoformed network of interlooped yarns by surrounding at least a portion of the core and occupying at least a portion of spaces between yarns in the thermoformed network of interlooped yarns.

13. The article of footwear of claim 9, wherein each raised element of the first set of raised elements and each raised element of the second set of raised elements extend in a z-direction away from an outer surface of the knitted upper.

14. The article of footwear of claim 13, wherein one or more of the first set of raised elements and the second set of raised elements include a first raised element having a first height in the z-direction and a second raised element having a second height in the z-direction, the second height different from the first height.

15. A method of manufacturing a knitted upper for an article of footwear, the method comprising:
knitting at least a first yarn to form the knitted upper;
thermoforming a first set of raised elements on a lateral side of the knitted upper, the first set of raised elements extending in a first direction on the lateral side of the knitted upper; and
thermoforming a second set of raised elements on a medial side of the knitted upper, the second set of raised elements extending in a second direction on the medial side of the knitted upper, the second direction different from the first direction, each of the first set of raised elements and each of the second set of raised elements comprising a thermoformed network of interlooped yarns each having a core, such that a thermoplastic elastomer interconnects the interlooped yarns by surrounding at least a portion of each core and occupying at least a portion of spaces between yarns in the thermoformed network of interlooped yarns.

16. The method of manufacturing the knitted upper for the article of footwear of claim 15, wherein the first direction is from a toe area of the knitted upper toward a heel area of the knitted upper, and wherein the second direction is from a lower area of the knitted upper toward a throat area of the knitted upper.

17. The method of manufacturing the knitted upper for the article of footwear of claim 15, wherein thermoforming the first set of raised elements and the second set of raised elements comprises:
positioning a first surface of the knitted upper adjacent a surface of a first mold plate, the surface having one or more cavities;
positioning a second mold plate adjacent an opposite second surface of the knitted upper; and
applying one or more of heat and pressure to one or more of the first mold plate and the second mold plate such that the one or more cavities of the first mold plate are at least partially filled with the thermoformed network of interlooped yarns to form the first set of raised elements and the second set of raised elements.

18. The method of manufacturing the knitted upper for the article of footwear of claim 17 further comprising forming the article of footwear using the knitted upper such that the first surface of the knitted upper forms an outer surface of the article of footwear.

19. The method of manufacturing the knitted upper for the article of footwear of claim 15, wherein thermoforming the first set of raised elements and the second set of raised elements comprises:
positioning a second surface of the knitted upper adjacent a surface of a first mold plate, the surface having one or more projections;
positioning a pliable, heat-resistant pad adjacent an opposite first surface of the knitted upper; and
applying one or more of heat and pressure to at least the first mold plate such that the one or more projections of the first mold plate push the thermoformed network of interlooped yarns into the pliable, heat-resistant pad to form the first set of raised elements and the second set of raised elements.

20. The method of manufacturing the knitted upper for the article of footwear of claim 19, further comprising forming the article of footwear using the knitted upper such that the first surface of the knitted upper forms an outer surface of the article of footwear.
